(19) United States
(12) Patent Application Publication
(10) Pub. No.: US 2011/0185354 A1
(43) Pub. Date: Jul. 28, 2011

(54) Mobile Application Delivery Management System

(75) Inventors: Christopher Clark Tanner, San Jose, CA (US); Rory W. Mather, St. Helena, CA (US)

(73) Assignee: Emdigo Inc.

(21) Appl. No.: 13/014,161

(22) Filed: Jan. 26, 2011

Related U.S. Application Data
(60) Provisional application No. 61/336,848, filed on Jan. 26, 2010.

(51) Int. Cl. G06F 9/445

(52) U.S. Cl. 717/178

(57) ABSTRACT

A computer implemented method and system is provided for managing delivery of mobile applications to a user's mobile device. A distribution server in communication with a transaction management server via a network is provided. The distribution server acquires identification information of the user's mobile device and one or more mobile applications. The distribution server determines the mobile device's network service information and characteristic information based on the identification information. The transaction management server initiates a mobile application delivery transaction based on the network service information and the characteristic information for generating a reference pointer for each of the mobile applications. The distribution server delivers the reference pointer to the mobile device based on the network service information and/or characteristic information. The reference pointer enables the user to perform actions associated with the mobile applications, which are tracked and analyzed for initiating marketing by a partner server via a marketing server.

### CROSS REFERENCE TO RELATED APPLICATIONS

This application claims the benefit of provisional patent application No. 61/336,848 titled “Deployable unified Mobile App store”, filed on 26 Jan. 2010 in the United States Patent and Trademark Office.

The specification of the above referenced patent application is incorporated herein by reference in its entirety.

### BACKGROUND

Delivery of mobile applications has not been possible on certain mobile technology platforms and mobile carriers outside of the mobile carriers' own on-device mobile application storefront. This issue has reduced the ability of mobile application publishers to market their products. Mobile application publishers are connecting with consumers in other marketing channels, for example, social media, online advertising, print and television media, brand websites, in-store and in-venue advertising, etc. However, because of the mobile application publishers' inability to connect consumers to their mobile applications from these venues, they are forced to directly rely on carrier and platform storefronts for market penetration of their mobile applications. Mobile application publishers are therefore completely dependent on mobile carriers for selling their products regardless of the strength of their brands, product implementations, or ability to market.

In some existing mobile application delivery systems, users, after creating an account on a mobile carrier's on-device mobile application storefront, are required to sign in to that account, choose a game to purchase, and confirm the billing model. The users thereafter receive a short message service (SMS) message on their mobile phones. The SMS message contains instructions on how to navigate several levels of phone menus to connect back to the mobile application storefront. When the users have navigated the menus, started the storefront application, connected to the network, and then navigated to the desired section of the mobile application storefront, they are again required to specify the purchase of the mobile application on their mobile phone and to confirm the purchase of the mobile application.

Users are often left frustrated when time investments in trying to buy a mobile application result in nothing more than network data charges without even allowing the user to purchase their desired mobile application. Over time, this frustration has made interested users reluctant to try purchasing mobile applications. An overall negative feedback loop is therefore created for marketing and selling mobile applications outside of a mobile carrier's or a mobile technology platform's on-device mobile application storefront. In turn, this has made the industry completely dependent on self-perpetuating silo storefronts and limited or ineffectual blind marketing.

Moreover, existing systems fail to deliver mobile applications, for example, games on certain combinations of mobile technology platforms and mobile carriers. Furthermore, these systems fail to create an accurate database of mobile application distribution information resulting in a significant percent of failed consumer experiences when the users attempt to purchase the mobile applications.

Furthermore, mobile application publishers face serious issues when they attempt to deliver mobile applications independent of the mobile application storefront. In general, the measured success rate of off-device mobile storefronts on other mobile carriers and mobile technology platforms is less than 50 percent. These failures are often the result of broken wireless access protocol (WAP) links delivered to the mobile phones. Furthermore, mobile application publishers have been unable to reconcile actual sales that have resulted from this delivery process, thereby making it difficult to gauge how changes to marketing or mobile application delivery processes actually improve their business. The above problems with mobile application delivery also result in consumer perception problems.

Hence, there is a long felt but unresolved need for a unified and effective computer implemented method and system that manages delivery of mobile applications to a mobile device of a user and that reverses the negative feedback loop of consumer perception and ineffectual marketing.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The computer implemented method and system disclosed herein addresses the above stated need for managing delivery of one or more mobile applications to a mobile device of a user. The computer implemented method and system disclosed herein reverses the negative feedback loop of consumer perception and ineffectual marketing, by effectively delivering quality reference pointers to the mobile applications on multiple mobile technology platforms across multiple mobile carriers or operators.

The computer implemented method and system disclosed herein provides a distribution server in communication with a transaction management server via a network. The computer implemented method and system disclosed herein also provides a mining server for generating and updating a distribution database in the distribution server with information related to multiple mobile applications. The mobile applications are located on one or more mobile application stores having mobile application storefronts. The mobile application store is an application or a website, for example, an on-device application, an on-device wireless application protocol (WAP) website, a website on a mobile device, an internet website, a personal computer application, etc., or a physical location such as a retail kiosk that sells mobile applications. The distribution server acquires identification information of the user's mobile device and one or more mobile applications. The identification information comprises, for example, a mobile number associated with the mobile device, and one or more alphanumeric strings, a binary value, a hex string, etc., uniquely identifying one or more mobile applications. The identification information is acquired, for example, from the user's mobile device, the distribution server, and/or external marketing parties via multiple input modes, for example, from browser dialog boxes, text boxes, browser cookies, etc., and messaging modes, for example, from short message service (SMS) messages, multimedia messaging service (MMS) messages, etc.

The distribution server determines network service information, for example, type of mobile carrier, and characteristic information, for example, the mobile device manufacturer, model, technology platform, etc., of the user's mobile device based on the acquired identification information. The network service information and the characteristic information are determined, for example, from an input from the user, a message from the user, a query to the distribution server, etc. The transaction management server, in communication with the distribution server, initiates a mobile application delivery transaction, for example, by selecting a transaction script, based on the determined network service information and the determined characteristic information of the mobile device. The mobile application delivery transaction generates a lead herein referred to as a “reference pointer” for each of the mobile applications. In an embodiment, the distribution server receives preferences associated with the mobile applications from the user and stores the preferences on the distribution server for allowing the transaction management server to generate the reference pointer to each of the mobile applications.

The distribution server delivers the generated reference pointer to each of the mobile applications on the mobile application stores, to the user's mobile device based on the determined network service information and/or the determined characteristic information of the mobile device. The reference pointer enables the user to perform actions associated with each of the mobile applications. The user's actions associated with each of the mobile applications comprise, for example, purchasing the mobile application from the mobile application storefronts, obtaining more information about the mobile applications, providing feedback about the mobile applications, etc.

The distribution server determines the mode of delivering the reference pointer, for example, using the determined network service information, the determined characteristic information, and device platform of the mobile device. The delivery of the reference pointer is performed, for example, via a messaging mode such as a short message service (SMS) message, a multimedia messaging service (MMS) message, an application-directed SMS, etc. The distribution server delivers the reference pointer to the mobile device across multiple device platforms, multiple application interfaces, multiple network services, and multiple characteristics of the mobile device. The distribution server configures the reference pointer to the mobile applications based on the acquired identification information, the determined network service information, and the determined characteristic information of the user's mobile device.

The distribution server determines the availability of the mobile applications on the distribution server based on the acquired identification information, the determined network service information, and the determined characteristic information of the mobile device. The distribution server delivers the reference pointer to the user's mobile device prior to or after determination of the availability of the mobile applications on the distribution server. On determining unavailability of one or more mobile applications on the distribution server, the distribution server redirects the user to one or more available mobile applications on the distribution server.

In an embodiment, the distribution server transmits one or more messages to the user's mobile device via one or more messaging servers for reinitiating the delivery of the mobile applications. In another embodiment, the distribution server transmits one or more messages to the user's mobile device via one or more messaging servers for requesting feedback on the delivery and quality of the mobile applications.

In an embodiment, the computer implemented method and system disclosed herein provides a marketing server in communication with the distribution server via the network. In an embodiment, the transaction management server tracks and analyzes the mobile application delivery transaction, progress of the delivery of the reference pointer, and the user's actions associated with the mobile applications. The information obtained from the tracking and the analysis, inputs from the user, and the information on the distribution server are stored on the transaction management server and the marketing server via the network. In an embodiment, the computer implemented method and system disclosed herein provides a partner server, in communication with one or more of the transaction management server, the distribution server, and the marketing server via the network, for initiating marketing of the mobile applications based on the stored information. The partner server generates an application interface for creating a mobile application storefront configurable on one or more of multiple device platforms. The application interface that creates the mobile application storefront is hosted on the marketing server, and enables the user to purchase one or more mobile applications and/or obtain information on the mobile applications. The transaction management server assigns a pointer to each of the actions associated with the mobile applications to track the purchase of the mobile applications by the user.

The computer implemented method and system disclosed herein further provides a marketing interface for receiving inputs from the user for initiating marketing of the mobile applications. The computer implemented method and system disclosed herein provides access of the information on the transaction management server, the distribution server, and the marketing server to one or more external marketing parties for marketing the mobile applications. The distribution server, the mining server, the transaction management server, the marketing server, and the partner server in communication via the network, manage the delivery of the mobile applications to the user's mobile device.

The computer implemented method and system disclosed herein enables marketing and distribution of mobile applications to existing communities of users wherever they might be. The computer implemented method and system disclosed herein delivers reference pointers to mobile applications across device platforms, mobile devices, etc., via, for example, social networking platforms, brand web sites, online retail storefronts, traditional brick-and-mortar storefronts, physical stores, and online banner advertisements. The computer implemented method and system disclosed herein provides new in-application, in-WAP, and on-device opportunities for marketing on mobile devices directly. The computer implemented method and system disclosed herein also allows mobile application publishers to effectively advertise their mobile applications, for example, via traditional print, radio, television, and stadium media.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIGS. 1A-1C illustrate a computer implemented method for managing delivery of one or more mobile applications to a mobile device of a user.

FIGS. 2A-2B exemplarily illustrate a flow chart comprising the steps for obtaining information on mobile applications to update a distribution database in a distribution server.

FIG. 3 exemplarily illustrates a flow chart comprising the steps performed by a mining server for updating the distribution database.

FIG. 4 illustrates a computer implemented system for managing delivery of one or more mobile applications to a mobile device of a user.

FIG. 5 exemplarily illustrates the architecture of a computer system employed for managing delivery of one or more mobile applications to a mobile device of a user.

FIGS. 6A-6B exemplarily illustrate a flow chart comprising the steps for managing delivery of one or more mobile applications to a mobile device of a user.

FIGS. 7A-7B exemplarily illustrate a flow chart comprising the steps for delivering a reference pointer to each of one or more mobile applications to a mobile device of a user and for initiating marketing.

FIG. 8 exemplarily illustrates a flow chart comprising the steps for initiating marketing of a mobile application via a marketing server.

FIG. 9 exemplarily illustrates a flow chart comprising the steps for initiating marketing of a mobile application to a list of users via the marketing server.

FIGS. 10A-10B exemplarily illustrate a flow chart comprising the steps for managing delivery of one or more mobile applications to a mobile device of a user using a single reference pointer.

### DETAILED DESCRIPTION OF THE INVENTION

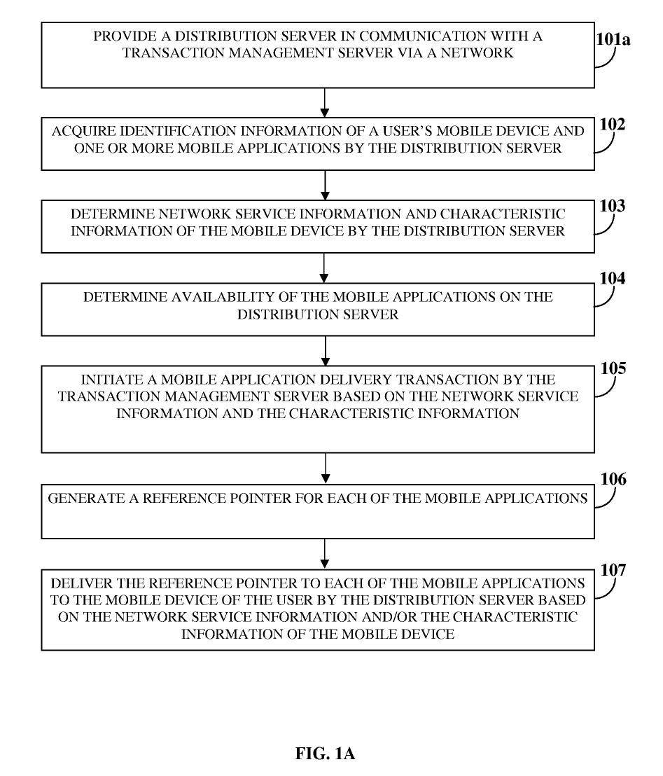

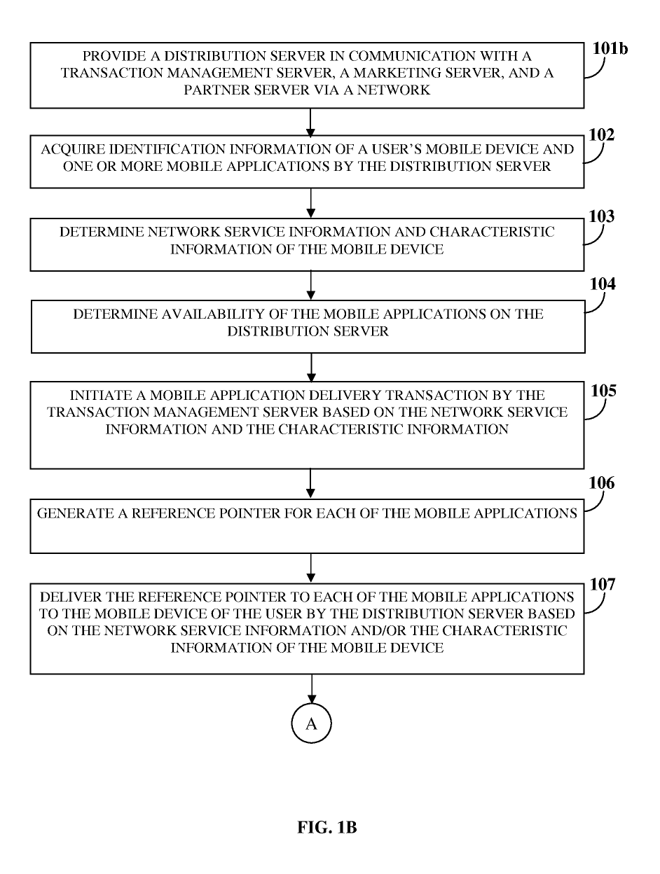

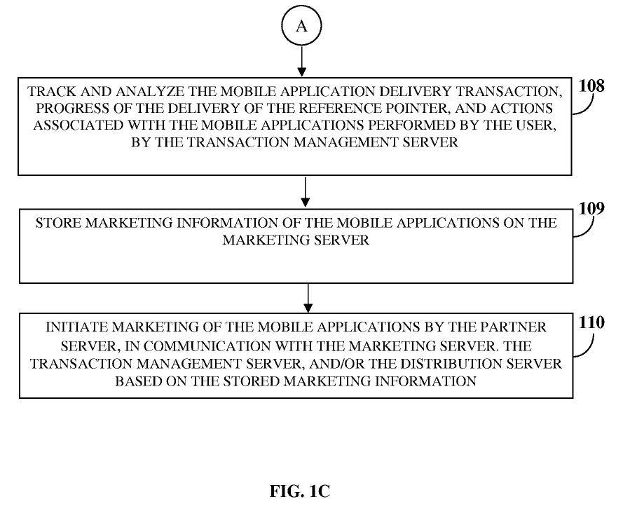

FIGS. 1A-1C illustrate a computer implemented method for managing delivery of one or more mobile applications to a mobile device of a user. As used herein, the term “user” refers to a consumer who interacts with the computer implemented system disclosed herein for browsing or purchasing mobile applications on a mobile device. Also, as used herein, the term “mobile device” refers to a portable device, for example, a cell phone device, a handheld device, a handheld computer, a tablet computing device, a personal digital assistant, etc., that can be identified by a phone number or other device identifier or communicated to via a network connection. Also, as used herein, the term “mobile application” refers to any application, program, or service that can be installed on the user's mobile device and that executes on the user's mobile device. The mobile applications can be written in any number of languages, for example, Java, C++, Flash, etc. The computer implemented method and system disclosed herein targets the mobile applications to multiple operating systems and run-time environments, for example, Java Platform Micro Edition (JME) of Sun Microsystems, binary runtime environment for wireless (BREW) platform, the iPhone® software development kit (SDK) of Apple Inc., the Android operating system of Google Inc., BlackBerry operating system of Research In Motion Limited, Windows® mobile operating system of Microsoft Corporation, the Palm operating system of Palm Inc., etc.

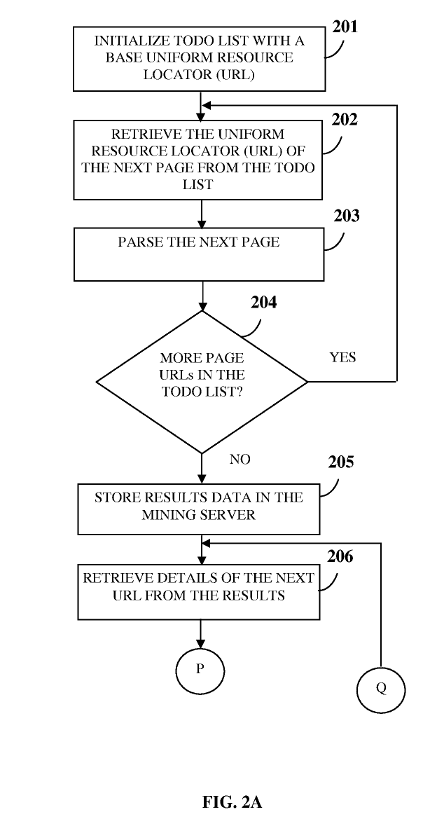

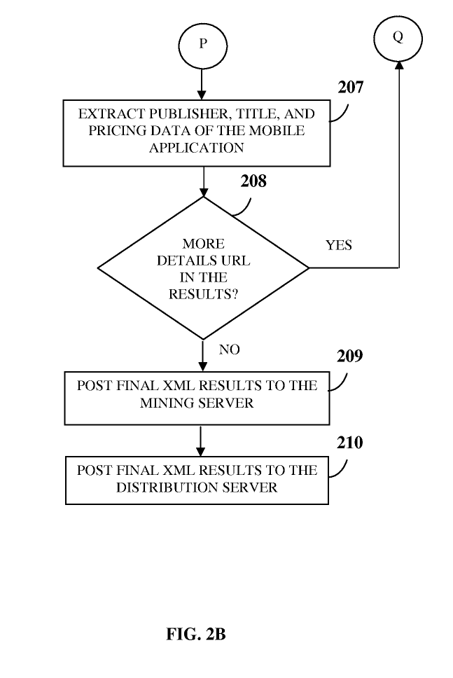

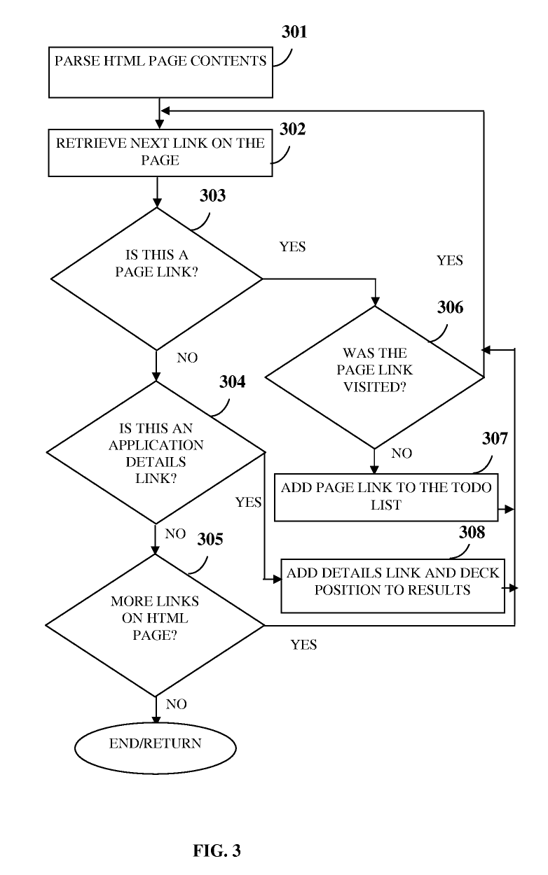

The computer implemented method disclosed herein provides 101a a distribution server in communication with a transaction management server via a network. The network is, for example, the internet, an intranet, a local area network, a wide area network, a WiFi communication network, a Bluetooth™ communication network, an infrared communication network, etc. The computer implemented method disclosed herein also provides a mining server for generating and updating a distribution database in the distribution server with information related to multiple mobile applications as disclosed in the detailed description of FIGS. 2A-2B and FIG. 3.

The distribution server acquires 102 identification information of the user's mobile device and one or more mobile applications. The mobile applications are located on one or more mobile application stores having mobile application storefronts. The mobile application store is an application or a website, for example, a wireless application protocol (WAP) website, an on-device application, a website on a mobile device, an internet website, a personal computer application, etc., or a physical location such as a retail kiosk that sells mobile applications. As used herein, the term “mobile application storefront” refers to an interface of the mobile application store that sells mobile applications. In an embodiment, the distribution server acquires the identification information of the user's mobile device without receiving the identification information of the mobile applications and customizes the mobile application store for the user's mobile device. The identification information of the mobile device comprises, for example, a mobile phone number associated with the mobile device, a number, an electronic mail address (email), an internet address, a media access control (MAC) address, etc. As used herein, the term “mobile phone number” is a unique identifier used to communicate with a mobile device. The mobile phone number comprises, for example, a country code, an area code, a local prefix, and a number. In an embodiment, the distribution server acquires other identification information, for example, a cookie on a browser application of the user's mobile device, a mobile carrier's unique subscriber string, etc., passed in a request to the distribution server to retrieve the mobile device number of the user. The identification information of the mobile applications comprises, for example, one or more mobile application identifiers such as an alphanumeric string, a binary value, a hex string, etc., uniquely identifying the mobile applications.

The distribution server acquires the identification information from, for example, the user's mobile device, the distribution server, and external marketing parties via multiple input modes and messaging modes. As used herein, the term “external marketing parties” refers to commercial business partners that utilize the distribution server, the transaction management server, and a marketing server of the computer implemented system disclosed herein to market and sell mobile applications. For example, the distribution server acquires the mobile phone number from a user's input in web browser dialog boxes, text boxes, browser cookies, etc., that store mobile numbers or identifiers of the user, from a mobile phone identifier that can be related to a mobile phone number stored on a third party database, short message service (SMS) messages, multimedia message service (MMS) messages, etc. As used herein, the term “SMS message” refers to a mobile message such as a short text message used for communication and delivered by a short message service center (SMSC). The SMSC is a mobile messaging gateway server that delivers messages to carrier networks. Also, as used herein, the term “MMS message” refers to a message containing multimedia content that is delivered to a mobile device via a multimedia messaging service center (MMSC). The MMS message is generally initiated via an interface on the MMSC. The MMSC comprises a server or a set of servers having an interface that initiates sending of MMS messages to mobile devices and returns information related to the status and delivery of those MMS messages. The MMSC utilizes transport protocols and MMS message specifications as its interface.

The distribution server can also extract the mobile phone number from an extensible markup language (XML) form sent from an SMSC during transmission of SMS messages. The distribution server also acquires the mobile phone number of the user's mobile device from information stored on its distribution database, from external marketing parties having access to multiple external databases of mobile numbers, a stored user identifier, SMS short codes, etc. As used herein, the term “stored identifier” refers to a unique identifier, for example, an automatically generated binary string, an American standard code for information interchange (ASCII) string, a mobile phone number, etc., that links transactions, events, and information about a particular user. Also, as used herein, the term “SMS short code” refers to a pseudo phone number used by mobile carriers to allow users to interact with premium mobile services via SMS and MMS.

The distribution server acquires one or more mobile application identifiers from text contained in a user initiated SMS, MMS, and from external marketing parties. The mobile application identifier can also be set via programming languages, for example, JavaScript, Flash®, etc. JavaScript is an internet scripting language. Flash® refers to the flash environment of Adobe Systems Incorporated. The distribution server also identifies the mobile application identifier from incoming SMS short code commands from a user. The SMS short code commands comprise pseudo phone numbers used by mobile carriers to allow users to interact with premium mobile services via SMS and MMS. The phone numbers are typically four or five digits in length. Mobile carriers are also able to charge fees to a mobile device user's bill based on the messages sent to the short code numbers. The distribution server determines the mobile phone number from incoming communication from the SMSC. The distribution server interprets the text in the SMS message and checks for SMS short code commands and mobile application identifiers. The distribution server determines validity of the mobile application identifier from the SMS message using a lookup table of the distribution database in the distribution server.

In an embodiment, the mobile number and the mobile application identifiers are encoded in a uniform resource locator (URL) or passed as hypertext transfer protocol (HTTP) parameters. HTTP is an internet protocol. As used herein, the term “HTTP parameters” refers to parameters that are passed between internet clients and internet services via the HTTP interface. The mobile phone number and the mobile application identifiers are passed using, for example, an HTTP GET command and an HTTP POST command.

The distribution server determines 103 network service information and characteristic information of the user's mobile device based on the acquired identification information. The network service information comprises information on the network operator or service provider, for example, a mobile carrier, a communications service provider (CSP), a wireless service provider, a wireless carrier, a cellular company, a mobile phone network operator such as Verizon Wireless, AT&T Wireless, T-Mobile® of T-Mobile USA, Inc., Sprint of Sprint Nextel Corporation, Cricket Wireless of Cricket Communications, Inc., etc. The characteristic information comprises, for example, manufacturer, model, technology platform, etc., of the mobile device. The manufacturer of the mobile device is the company manufacturing a particular mobile device, for example, LG Electronics, Motorola, Samsung, HTC Corporation, Apple Inc., etc. The model of the mobile device is the type of mobile device in the mobile device manufacturer's product line, for example, the Voyager™ of LG Electronics, the iPhone® of Apple Inc., the Blackberry® Pearl™ of Research In Motion Limited, the Samsung GLEAM., the MOTORAZ® of Motorola Inc., etc. The distribution server determines the models of mobile devices and their respective mobile carriers. For example, LG Electronics manufactures different mobile device models, for example, the Voyager™ Chocolate, Voyager, Chocolate, enV, VX8350, etc., that operate on Verizon Wireless.

The distribution server determines the network service information and the characteristic information from, for example, an input from the user, a message from the user, a query to the distribution database, a mobile carrier database, etc. The distribution server sends a query to its internal distribution database, a mobile carrier database, etc., with the mobile device's identification information such as the mobile phone number. A response to the query comprises, for example, the network service carrier, the manufacturer and the model of the mobile device, etc. In an embodiment, a string passed via a web browser identifies the characteristic information of the mobile device. The distribution server therefore determines the characteristic information of the mobile device from a user's input, from a user agent lookup table in the distribution database, from a partial match in a mobile device database, or from a user agent profile string-based lookup table in the mobile device database. The user agent profile string is obtained from an XML file returned from, for example, the MMSC as a result of contacting the user's mobile device with an MMS.

The distribution server identifies the user's mobile device or representative mobile device based on the determined network service information and the characteristic information using multiple identification methods. The network service information and the characteristic information are used to access a transaction database in the transaction management server that communicates with the distribution server via the network. The transaction database is a database of scripted transactions used for determining the appropriate identification method for the user's mobile device. The transaction database allows usage of different device identification methods for different mobile platforms on different mobile carriers associated with different messaging modes and different device interaction paradigms. For example, on Verizon's wireless network, an MMS can be used to get a unique mobile device identifier that can be used to retrieve information on a specific mobile device in a mobile device database comprising different mobile device identifiers for all mobile devices from Verizon.

In an embodiment, a WAP push message is sent to prompt a user to click on a reference link. WAP refers to a secure specification for application layer network communications in a wireless communication environment. WAP allows users to access information instantly via handheld wireless devices such as mobile devices, pagers, two-way radios, smart phones, communicators, etc. WAP supports multiple wireless networks and supports a hypertext markup language (HTML), an extensible markup language (XML), a wireless markup language (WML) based on XML, WMLScript, etc. WAP is supported by multiple operating systems. WML is devised for small screens and single hand navigation without a keyboard. WML is scalable from two-line text displays to graphic screens found on mobile phones, tablet computing devices, communicators, etc. The WAP push message is an SMS message sent to the user's mobile device that actively requests the user of the mobile device to accept to be redirected to a WAP website via a WAP hyperlink. When the WAP hyperlink is accessed, the WAP hyperlink causes a browser on the user's mobile device to load a web page of the WAP website. The distribution server uses a mobile device's user agent sent along with an HTTP request to identify the mobile device. As used herein, the term “user agent” refers to a string passed by the mobile device's browser to identify the mobile device's manufacturer and model number. In this case, a single interaction is sufficient to determine the mobile device and choose a transaction script for delivering a reference pointer or link to the mobile device, and for initiating marketing of the mobile applications.

In another embodiment, an SMS and a WAP push message is sent to identify the user's mobile device because certain mobile devices do not respond to the WAP push messages and certain other mobile devices cannot direct users to the mobile application storefronts using SMS messages. In another embodiment, the distribution server provides a direct service interface for determining a mobile device identifier, for example, via short message service center (SMSC) interaction and/or multimedia messaging service center (MMSC) interaction. Each combination of a mobile carrier, the mobile device, and a device platform requires different identification methods for identifying the mobile device. The transaction management server enables retrieval of different mobile device identification methods from the transaction database comprising one or more scripts for identifying the mobile device based on the determined network service information and the determined characteristic information of the mobile device.

The computer implemented method disclosed herein implements WAP hyperlinks that allow for a single HTML or WAP hyperlink to automatically support distribution of all versions of mobile applications across multiple mobile carriers, mobile technology platforms, and mobile application storefronts. The computer implemented method disclosed herein implements these WAP hyperlinks by using WAP protocols and mobile device browser user agents to identify a mobile device browser, determine a mobile carrier, a mobile device manufacturer, and a mobile device model from the distribution database, cross reference the availability of the mobile applications using the distribution database, and then to re-direct the user who accessed the WAP hyperlink directly to the mobile application storefront. The user may also input their mobile device number on the WAP web page.

On identifying the user's mobile device, the distribution server determines 104 availability of the mobile applications on the distribution server by querying the distribution database. As used herein, the term “availability” refers to whether or not a particular mobile application is supported by the user's mobile device based on the network service information and characteristic information of the mobile device. The delivery of a reference pointer to each of one or more mobile applications to the user's mobile device is based on the availability of the mobile applications on the distribution server. The distribution server employs real time relational database management technologies, for example, MYSQL® from Oracle Corporation for determining availability of the mobile applications. In an embodiment, the availability of the mobile applications is determined via a computer file system query by flattening the mobile device identifier and the mobile application identifier keys directly into the file system. The distribution server determines the availability of the mobile applications based on the acquired identification information, the determined network service information, and the determined characteristic information of the mobile device.

The distribution server delivers the reference pointer to the user's mobile device prior to or after the determination of the availability of one or more mobile applications. On determining unavailability of one or more mobile applications on the distribution server, the distribution server redirects the user to one or more available mobile applications on the distribution server. Consider an example where the user requests for a mobile application via an SMS or MMS. The user initiates a short code SMS request with a mobile application keyword. An SMSC integration short code handler, for example, on an SMSC messaging server, parses the request and validates the mobile application keyword by querying the distribution database. The distribution server receives the incoming SMS via a network interface sent from the SMSC. The distribution server's application interface comprises the incoming SMS interface and extracts the mobile phone number and the contents of the SMS, which contain the mobile application keyword identifier. The distribution server determines the availability of the requested mobile application. If the mobile application is available, the distribution server delivers the reference pointer to the mobile application to the user's mobile device. If the mobile application is unavailable for purchase on the distribution server, the reference pointer redirects the user to a web page displaying one or more available mobile applications.

The transaction management server, in communication with the distribution server, initiates 105 a mobile application delivery transaction, for example, by selecting a transaction script from the transaction database in the transaction management server based on the determined network service information and the determined characteristic information of the mobile device for delivering the mobile application. As used herein, the term “transaction script” refers to a computer program in different programming languages that defines a set of atomic actions and conditionals required to generate and initiate delivery of a lead herein referred to as a “reference pointer” to a particular mobile application to a particular mobile device. As used herein, the term “reference pointer” refers to a wireless application protocol (WAP) link, a referral uniform resource locator (URL), a mobile application store hyperlink, a mobile application-directed SMS used to directly interact with the mobile application storefront, an internet hyperlink defined via a hypertext markup language (HTML) and interpreted by an internet browser, for example, a web browser such as Internet Explorer® of Microsoft Corporation, Firefox® of Mozilla Corporation, etc., that retrieves, displays, and allows exchange of content resources on the world wide web (WWW). Also, as used herein, the term “application-directed SMS” refers to a mobile message sent to a mobile device via a mobile carrier's short message service and directed to a particular mobile application or service on the mobile device. The application-directed SMS messages may or may not be seen by the users as part of their SMS interface. The application-directed SMS refers to any message transmitted to a mobile device that will be automatically handled by a mobile application installed on the mobile device.

The mobile application delivery transaction is initiated by the transaction script and a set of associated states that track the progress of the delivery of the reference pointer. The transaction script tracks the state of delivery of the reference pointer, waits for external actions or results, and performs optional execution. The transaction management server retrieves mobile application delivery information from the distribution server. The mobile application delivery information comprises, for example, sets of instructions for delivering the mobile applications to the user's mobile device. Each of the instructions comprises, for example, delivery uniform resource locators (URLs), alpha-numeric or binary identifiers of the mobile application storefronts, designators of the mobile application storefronts, etc. Based on the mobile application delivery information, the transaction management server then selects an appropriate delivery method, looks up the appropriate transaction script from the transaction database, and then executes the transaction script with the appropriate information for generating 106 the reference pointer for the requested mobile application.

The selection of transaction scripts from the transaction database based on the determined network service information and the determined characteristic information of the mobile device provides a unified method for delivering the mobile applications via a single interface. The computer implemented method and system disclosed herein can deliver the mobile application via a single link or reference pointer regardless of the mode of access, for example, from an on-device browser, a browser of a personal computer, an on-device electronic mail (email) client, etc. The reference pointer, for example, a mobile application store hyperlink, when accessed, brings a browser of the mobile device to a purchase screen for a particular mobile application.

In an embodiment, the reference pointer redirects the browser of the user's mobile device directly to the mobile application storefront using the mobile application delivery information. In another embodiment, the distribution server uses the selected transaction script to send a separate WAP push message or an application-directed SMS to direct the user's mobile device to the mobile application storefront. In another embodiment, the transaction script provides the user with direct feedback and/or instructions to ensure completion of the transaction.

In an embodiment, the transaction management server, in communication with the distribution server via the network, tracks and analyzes the mobile application delivery transactions, the generated reference pointers, and the selected transaction scripts associated with the mobile applications, and stores information on the tracked and analyzed mobile application delivery transactions on the transaction management server and the marketing server via the network.

The distribution server, in communication with the transaction management server via the network, delivers 107 the generated reference pointer to each of the mobile applications to the user's mobile device based on the determined network service and/or the determined characteristic information of the mobile device. The reference pointer enables the user to perform actions associated with each of the mobile applications. As used herein, the “actions” performed by the user refer to interactions and actions performed by the user with the distribution server and the transaction management server to view and/or purchase mobile applications. The actions are, for example, downloading or purchasing the mobile applications, obtaining more information about the mobile applications, etc.

On accessing the reference pointer or receiving the reference pointer on the mobile device, the user is taken to a purchase screen of a particular mobile application. The distribution server delivers the reference pointer to the user's mobile device via a messaging mode, for example, a short message service message, a multimedia message service message, etc. The distribution server determines the mode of the delivery of the reference pointer using the determined network service information, the determined characteristic information, and the device platform of the mobile device. The device platform refers to any set of mobile device software operation systems, programming languages, and/or application programming interfaces in the mobile device industry that represent a distributable platform for mobile device applications. Examples of the device platform comprise, for example, Java Platform Micro Edition (JME) of Sun Microsystems, binary runtime environment for wireless (BREW) platform, the iPhone® software development kit (SDK) of Apple Inc., the Android operating system of Google Inc., BlackBerry operating system of Research In Motion Limited, Windows® mobile operating system of Microsoft Corporation, the Palm operating system of Palm Inc., etc.

The reference pointer is associated with a network identifier (NID) for the network service information, and a characteristic identifier (CID) for the characteristic information, in addition to the mobile application identifier in the distribution database in the distribution server. The reference pointer is retrieved based on the NID and CID in the distribution database associated with the reference pointer for a mobile application. In an embodiment, a pointer automatically determines the network service information, the characteristic information via HTTP parameters associated with a mobile device browser that accesses the reference pointer. The distribution server can deliver the reference pointer across multiple device platforms, multiple application interfaces, multiple network services, and multiple characteristics of the mobile device via, for example, SMS, MMS, WAP push messages, etc. As used herein, an “application interface” refers to an internet browser page or a mobile application store that allows purchase of a mobile application through a mobile carrier or a mobile platform or a third party billing mechanism.

In an embodiment, the distribution server configures the reference pointer to one or more mobile applications based on the acquired identification information, the determined network service information, and the determined characteristic information of the mobile device. In an embodiment, the distribution server receives preferences associated with the mobile applications from the user and stores the preferences in the distribution database for allowing the transaction management server to generate the reference pointer to each of the mobile applications. In this embodiment, if the mobile application is present on multiple mobile application stores, the distribution server redirects the user to one or more mobile application stores based on the user's preferences and a mobile application publisher's preferences. For example, the user specifies a preference to receive the mobile application from the Blackberry mobile application store. If a desired mobile application is present on more than one mobile application store, for example, at stores of Research In Motion and AT&T Inc., then the distribution server queries the user's preference as a part of the transaction script and redirects the user to the required mobile application store based on the user's preferences. Moreover, a mobile application publisher can specify a preference to deliver the mobile application to AT&T's mobile application store by default. The computer implemented method and system disclosed herein is capable of handling multiple preferences and delivery the mobile applications based on the user's preferences and/or the mobile application publisher's preferences.

Consider an example where the distribution server uses a user's mobile device number to determine a mobile operator hosting the user's mobile service and then uses the mobile operator's MMS handset profiling application programming interface (API) or other messaging partner provided API to uniquely identify the characteristic information of the user's mobile device and obtain a unique identifier for the user's mobile device. The distribution server looks up the unique identifier of the user's mobile device in a database of identifiers to obtain the matching mobile device. The distribution server then determines the availability of the mobile application for the matching mobile device and mobile application delivery information for the requested mobile application on that mobile device as well as the necessary WAP, SMS, MMS, or application-directed SMS transaction method necessary to deliver the reference pointer. The distribution server also uses a unique mobile application store identifier in the distribution database for delivering the reference pointer in the form of an application-directed SMS to the user's mobile device to cause the mobile application store to launch to the purchase/download screen for the mobile application on the mobile device. The user's mobile operator is also determined by sending a WAP push message to the user's mobile device via the mobile operator's messaging interface. The distribution server can also determine the characteristic information of the mobile device when the user clicks on the reference pointer, which automatically redirects the mobile device browser to the corresponding WAP purchase/download page for the mobile application or to another page informing the user of other mobile applications available on the mobile device, when the desired mobile application is not available.

The computer implemented method disclosed herein also provides 101b the marketing server and a partner server in communication with the distribution server via the network. In an embodiment as exemplarily illustrated in FIGS. 1B-1C, the transaction management server, in communication with the distribution server via the network, tracks and analyzes 108 the mobile application delivery transaction, progress of the delivery of the reference pointer, and the actions associated with the mobile applications performed by the user and stores information obtained from the tracking and the analysis in a transaction database in the transaction management server and on the marketing server via the network. The information obtained from the tracking and the analysis performed by the transaction management server is herein referred to as “tracked and analyzed information”. Marketing information comprising, for example, the tracked and analyzed information, inputs from the user, and information on the distribution server is stored 109 on the marketing server via the network. The inputs from the user comprise, for example, feedback associated with the mobile applications, user behavior, user actions on the reference pointer to the mobile application, etc. The information in the distribution server refers to information on the mobile applications, network service information of the mobile device, characteristic information of the mobile device, mobile application delivery information, etc.

The transaction management server tracks each action independently using a reference pointer delivery script and the tracked and analyzed information. The transaction management server determines the reference pointer delivery script for the delivery of the mobile applications for particular network service information and characteristic information of the mobile device using transaction information stored on the transaction management server. In addition to storing information on the delivery of the reference pointer to one or more mobile applications, the transaction management server also stores information related to the delivery of mobile applications in the transaction database in the transaction management server. In an embodiment, the transaction management server assigns an additional pointer to each of the actions associated with the mobile applications to track the user's purchase of the mobile applications.

Consider an example where the user receives a reference pointer to a mobile application on the user's mobile device. The reference pointer is associated with an additional pointer. The user clicks on the reference pointer to buy the mobile application. The tracked and analyzed information comprising the tracked and analyzed actions, inputs from the user, and information on the distribution server, information on the mobile applications, the reference pointer to the mobile applications, the network service information of the mobile device, the characteristic information of the mobile device, the transaction script used to deliver the reference pointer to the mobile device, etc., is stored on the transaction management server. The transaction management server retrieves the tracked and analyzed information regarding the user's actions to decide on the transaction script to be used for delivering the mobile application for similar network service information, characteristic information, etc., for the mobile application.

In an embodiment, other information pertaining to the marketing information can also be stored along with the transaction. For example, mobile publishers can create marketing campaign identifiers that are used to track and analyze a particular marketing campaign. In this embodiment, campaign identifiers are tracked along with other information for each transaction. The transaction management server directly tracks metrics related to user behavior, for example, branching factors, net growth factor, failed reference pointers generated, and branches terminated due to non-supported mobile devices during interaction with the computer implemented system disclosed herein and is therefore able to provide direct metrics relative to the marketing campaign. The tracked metrics further comprise, for example, ratio of available versus unavailable mobile application requests, sell through and send through rates based in the marketing channel and campaign tags, overall popularity of device manufacturer, model, carrier, device platform, etc., percentage of users unable to complete transactions, etc. The transaction management server stores the tracked metrics on the transaction management server, distribution server, and the marketing server.

In an embodiment, the distribution server transmits one or more messages, for example, SMS messages, MMS messages, etc., via one or more messaging servers to the user's mobile device for reinitiating the delivery of the mobile applications. In another embodiment, the distribution server transmits one or more messages, for example, SMS messages, MMS messages, etc., via one or more messaging servers to the user's mobile device for requesting feedback on the delivery and quality of the mobile applications. For example, on purchasing a mobile application, the user receives a message requesting the user to provide feedback on the experience during purchase and delivery, the quality of the mobile application, review on the mobile application, etc. The feedback is stored on the distribution server and the marketing server.

The partner server, in communication with one or more of the marketing server, the transaction management server, and the distribution server via the network, initiates 110 marketing of one or more mobile applications based on the stored marketing information. The partner server accesses the tracked and analyzed information from the marketing server. Moreover, the partner server uses the tracked metrics and the tracked and analyzed information stored on the marketing server. In an embodiment, the transaction management server directly transmits the tracked metrics to the partner server. The partner server uses the tracked metrics to analyze multiple aspects of marketing and sales of mobile applications from distribution of marketing materials via online or offline modes to the actual confirmed purchase and/or installation of the mobile applications being marketed.

A partner operating the partner server initiates marketing of the mobile applications using a campaign deployment and configuration module that enables a related mobile application delivery campaign on the marketing server. The partner operating the partner server also configures new applications for the distribution server via an application marketing configuration module that allows specification of marketing images, marketing text, mobile application delivery information, or linkage information, for example, text, to be used on a mobile application storefront to associate information related to delivery and distribution of mobile applications. The specified information allows the distribution server, the marketing server, the transaction management server, and the partner server to initiate and fulfill marketing and delivery requests of the mobile applications.

Partners operating the partner server are given mobile application deployment information in the form of marketing interface configuration information. The marketing interface allows initiation of marketing of one or more mobile applications. As used herein, the term “marketing interface” refers to any form of interface that interacts with the distribution server to initiate mobile application delivery transactions associated with one or more mobile applications. The marketing interface comprises, for example, a hypertext markup language hyperlink, JavaScript based buttons and widgets, hypertext markup language (HTML) components, SMS message keyword and short codes that can be advertised from print, radio or television media, embedded online or on device advertisements, retail kiosks, online storefronts, or installed on the mobile device. The marketing interface allows access to information on the marketing server using which a user can request information on one or more mobile applications, perform actions related to the delivery of reference pointers to one or more mobile applications, and update information associated with one or more mobile applications on the marketing server.

The marketing interface receives inputs from the user for the initiation of marketing of one or more mobile applications. In an embodiment, a marketing mobile application, for example, a mobile application, an internet application accessed via a mobile web browser, an embedded library that can be compiled into a mobile application, a desktop application, etc., is provided on a first user's mobile device to market one or more mobile applications by a first user to a second user having any type of mobile device, mobile carrier, device platform, etc. As used herein, the first user is a user who sends or refers mobile applications to one or more second users. The second user is a user who receives the messages for purchase of mobile applications. The first user suggests a mobile application to the second user when the first user believes that the second user has an interest in the mobile application. The first user sends a request, for example, by entering referral message text, a target mobile phone number, and a mobile application identifier associated with the mobile application to be marketed via the marketing mobile application. The request may be implemented using, for example, HTML, Flash, JavaScript, C++, etc., in an existing mobile browser application or as computer program code compiled into installed mobile applications. A marketing message, triggered using the entered information, is delivered to a target mobile phone number or an electronic mail address.

The marketing mobile application or client initiates marketing by communicating with the marketing server's marketing interface, which in turn initiates a mobile application delivery transaction with the transaction management server. The marketing server hosts marketing information and one or more marketing interfaces in a scalable manner. In an embodiment, the marketing server comprises a scalable network of multiple marketing servers. The marketing server's assets and programming code related to web-based interaction with users of web-enabled devices are related to the marketing and delivery of mobile applications. The marketing server's assets and programming code can be used as a “front end” to perform communication for web-based marketing via web-based protocols. On receiving the marketing message, the second user responds to the marketing message with a response message. The second user responds with a confirmation keyword such as “yes” or the mobile application identifier to accept the delivery of the mobile application. The second user can also opt out of receiving the marketing message. The marketing server manages mobile marketing campaigns that use SMS messages or MMS messages to communicate with mobile devices for marketing mobile applications. The marketing mobile application allows users to respond to the marketing messages to initiate delivery of the reference pointers to the mobile applications.

In another embodiment, the marketing mobile application is used to perform viral marketing on the mobile device across multiple mobile carriers, mobile platforms, mobile devices, and mobile messaging systems. The marketing mobile application offers viral marketing and recommendations from the computer implemented system disclosed herein, for example, via web-based interfaces on personal computers, television sets, game consoles, blu-ray players, etc. Viral marketing can be directly implemented via one or more marketing modules on the marketing server, which interface with web-based marketing client applications to initiate delivery transactions via the transaction management server. The marketing server automatically generates WAP pages that allow users to enter target mobile device numbers along with referral messages. This enables integration of viral marketing by launching a WAP browser targeting an HTTP address with the mobile application identifier as part of the address or as a parameter.

In an embodiment, one or more external marketing parties are provided with indirect access to the transaction management server, the distribution server, and the marketing server via the partner server for marketing one or more mobile applications. The marketing server stores marketing information and availability information for the mobile applications. The external marketing parties interact with multiple users based on the marketing modules using network service information, user and mobile device identification information, and characteristic information in a marketing database of the marketing server. External marketing parties create marketing campaigns associated with marketing campaign tags that uniquely identify the marketing campaign to market one or more mobile applications stored on the distribution server. The marketing campaign tags allow external marketing parties to track metrics for each marketing campaign independently. The marketing campaign tags are tracked and associated with transactions stored in the transaction database of the transaction management server. The marketing campaigns are displayed via one or more marketing channels comprising any venue for mobile applications, for example, on-device mobile application stores, brand websites, social networks such as facebook® of Facebook, Inc, twitter™ of Twitter, Inc. etc., advertisements, retail kiosks, print media, radio media, television media, messaging campaigns such as SMS messaging campaigns and MMS messaging campaigns, etc.

The metrics of the marketing campaigns are tracked independently for each marketing campaign. The marketing campaigns are customized based on information on one or more users on the distribution server. Marketing campaigns are tracked based on log information stored on the marketing server, the transaction management server, and the distribution server. The tracked marketing campaigns are analyzed on a campaign analytics module of the partner server.

In another embodiment, the partner server groups a set of users who have opted to market mobile applications together either explicitly or implicitly based on predetermined criteria. The partner server stores the groups via abstract references in a user database in the transaction management server. The predetermined criteria comprise, for example, the characteristic information of the users' mobile devices, the users' mobile application purchases, the users' preferences and interests based on the feedback after purchase, the users' transaction history, the users' information from external marketing parties and third party databases, etc. User specific information is stored securely on the transaction management server whereas specific groups of users are tracked via references on the partner server. External marketing parties or partners use an opt-in set management module of the partner server to create sets of targeted users by retrieving opted users based on specific criteria directly or indirectly from the transaction management server's user database. In an embodiment, the transaction management server is configured as a network of master slave servers where one slave server provides read-only access to the user database from the campaign analytics module and the opt-in set management module of the partner server.

In another embodiment, an application interface for the creation of a mobile application storefront configurable on multiple device platforms is generated via a store configuration module on the partner server and hosted on the marketing server. The application interface enables the user to purchase one or more mobile applications or obtain information on one or more mobile applications. The application interface is, for example, an on-device application, a WAP website, an on-device website, an internet website, a personal computer application, a retail kiosk, etc. Consider an example where the application interface shows a web page displaying a list of links to mobile applications, associated mobile application information comprising network service information, characteristic information, etc., on each mobile application on the user's mobile device. The user can click on the link for the mobile application of the user's choice to either purchase the mobile application or obtain the associated mobile application information. The user can also purchase the mobile application through the application interface via a third party billing interface integrated with the application interface.

In an embodiment, a third party billing is implemented by means of a callback or a URL request to a third party mobile application store provider's billing server. The transaction management server utilizes the transaction database that stores the mobile application storefront's billing system URLs or secure scripted transactions for customizing billing integration for each created mobile application storefront. In this case, a destination mobile application storefront handles the billing. The marketing server automatically generates a web interface or a WAP interface, for example, a purchase button and a confirmation screen that uses the transaction management server's associated scripted transaction for billing based on which the created mobile application storefront initiated the billing transaction. In another embodiment, the transaction management server directly interfaces with the SMSCs, carrier billing systems, or secure billing transactional servers, for example, PayPal to implement direct or indirect billing. Therefore, the distribution server, the transaction management server, the marketing server, and the partner server in communication via the network manage the delivery of one or more mobile applications to the mobile device of the user.

FIGS. 2A-2B exemplarily illustrate a flow chart comprising the steps for obtaining information on mobile applications to update the distribution database in the distribution server. The mining server determines which mobile applications exist on a mobile carrier's mobile application storefront periodically, for example, every week, to account for updates on the mobile carrier's mobile application storefront. The distribution database provides the mining server with the network service information and the characteristic information of one or more mobile devices, associated mobile carriers, etc., to uniquely identify each mobile device. The mining server repeats the steps of obtaining information on the mobile applications for each mobile device.

The mining server initializes 201 a “ToDo” list with a base URL link of the mobile application storefront. The initialization serves as a starting point for obtaining information on the mobile applications. The mining server retrieves 202 the URL link of the next page from the ToDo list. The URL link of the next page points to a new undiscovered page. The mining server parses 203 the contents of the next page as disclosed in the detailed description of FIG. 3. The mining server determines 204 if there are more URL links of pages in the ToDo list. If there are more URL links of pages in the ToDo list, the mining server retrieves 202 the URL link of the next page from the ToDo list. If there are no more URL links to pages in the ToDo list, the mining server stores 205 the results data, that is, the gathered intermediate page content results or page content information related to the mobile applications in the mining server. An original query string used to invoke the steps of obtaining information of mobile applications along with the intermediate page content results are saved in the mining server. The step of saving allows for multiple steps over two phases and guards against network failures, when posting information to the distribution server.

The mining server retrieves 206 the details of the next URL, for example, mobile application's title, etc., from the intermediate page content results along with the link to the details. Using the link to the next details, the mining server downloads an HTML file and extracts 207 information on the title of the mobile application, the publisher of the mobile application, and the pricing data of the mobile application. The mining server determines 208 if there are more mobile application titles to extract information on the mobile applications. If there are more mobile application titles to extract information on the mobile applications, then the mining server retrieves 206 the next details from the intermediate page content results along with the link to the details. If there are no more mobile application titles to extract information on the mobile applications, the mining server posts 209 the final results in an XML format to the mining server for redundancy. The mining server then posts 210 the final results in the XML format to the distribution server to update the distribution database in the distribution server.

FIG. 3 exemplarily illustrates a flow chart comprising the steps performed by the mining server for updating the distribution database. The mining server parses an HTML page of a mobile application storefront. The mining server parses 301 the contents of the HTML page by using the URL link of the HTML page. The mining server supplies necessary username and password authentication information in order to pass the mobile carrier's security precautions. The mining server retrieves 302 the next link found on the HTML page. The next link is in the form of an anchor link or an <ahref> link. The mining server determines 303 if the next link points to another HTML page that lists mobile applications. The determination is performed based on specific tags in the HTML page. If the next link does not point to another HTML page that lists mobile applications, then the mining server determines 304 if the next link is a link to an application details page. If the next link is an application details link, the application details link is added 308 and saved along with an overall position within the wireless portal hierarchy. If the next link is not an application details link, the mining server determines 305 if there are more links on the HTML page and if all the links on the HTML page have been processed on the HTML page. If there are more links on the HTML page, the mining server retrieves 302 the next link on the HTML page and the process repeats. If there are no more links, the steps of parsing the HTML page is complete. The ToDo list comprises the newly discovered HTML pages and the result set contains mobile application titles along with page details of the mobile application.

If the next link points to another HTML page listing mobile applications, then the mining server determines 306 if the HTML page has already been visited. If the HTML page has already been visited, then the mining server does not process the HTML page again and retrieves 302 the next link on the HTML page. If the HTML page is a newly discovered page, then the mining server adds 307 the page link on the ToDo list and proceeds to retrieve 302 the next link on the HTML page.

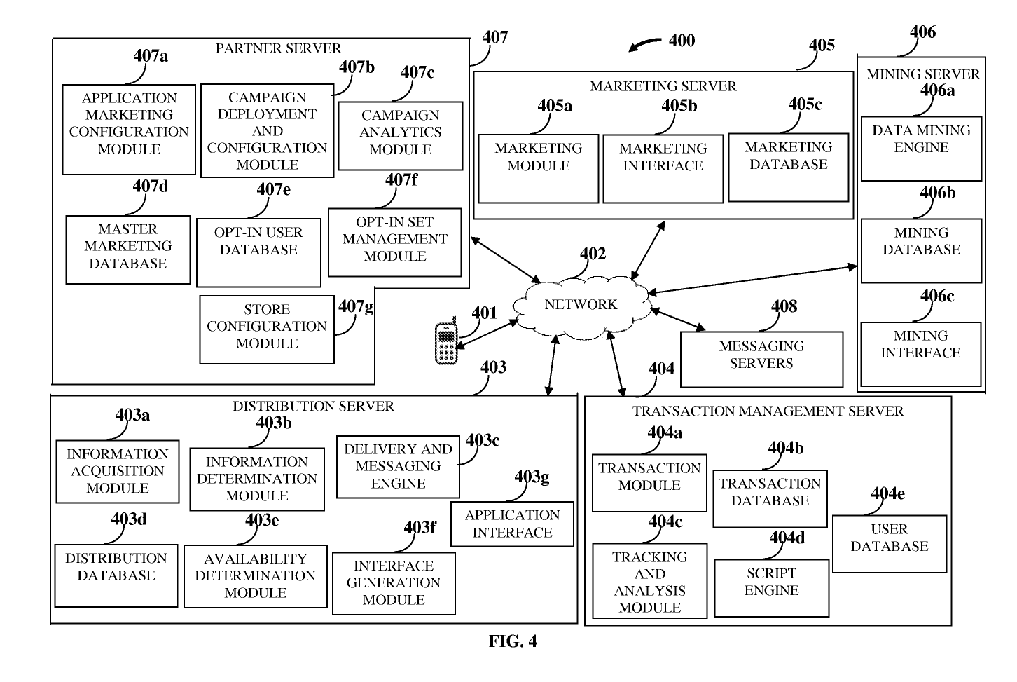

FIG. 4 illustrates a computer implemented system 400 for managing delivery of one or more mobile applications to a mobile device 401 of a user. The computer implemented system 400 disclosed herein comprises a distribution server 403 in communication with a transaction management server 404, a marketing server 405, a mining server 406, and a partner server 407 via a network 402. The computer implemented system disclosed herein communicates with one or more messaging servers 408, for example, an external SMSC messaging server, a MMSC messaging server, an electronic mail (email) messaging server, etc., to communicate with mobile devices 401 and send messages to the mobile devices 401. The messaging servers 408 interact directly with mobile carriers for delivering the mobile applications to the mobile devices 401.

The distribution server 403 comprises an information acquisition module 403a, an information determination module 403b, a delivery and messaging engine 403c, a distribution database 403d, an availability determination module 403e, and an interface generation module 403f. The information acquisition module 403a acquires identification information, for example, the mobile phone number, of the user's mobile device 401 and identification information, for example, the mobile application identifiers of one or more mobile applications. The information determination module 403b determines network service information, for example, type of mobile carrier, and characteristic information, for example, the model and manufacturer of the user's mobile device 401 based on the acquired identification information. The delivery and messaging engine 403c delivers a reference pointer to each of the mobile applications to the user's mobile device 401 based on one or more of the determined network service information and the determined characteristic information of the user's mobile device 401. The delivery and messaging engine 403c delivers reference pointers to mobile applications via a series of managed mobile device interactions and user interactions across multiple device platforms and mobile carriers. The delivery and messaging engine 403c interacts with the messaging servers 408, for example, the SMSC messaging server, the MMSC messaging server, and the email messaging server via the network 402 for transmitting one or more messages to user's mobile device 401 for reinitiating the delivery of the mobile applications and for requesting feedback on the delivery and quality of the mobile applications from the user.

The distribution database 403d is a relational database of information necessary to deliver the reference pointer to one or more mobile applications to the user's mobile device 401. The distribution database 403d stores the acquired identification information, the network service information of the user's mobile device 401, the characteristic information of the user's mobile device 401, device platform information, pricing of the mobile application, mobile application delivery information, mobile application distribution information, the network identifier (NID), the characteristic identifier (CID), etc. The mobile application distribution information comprises, for example, mobile device support information, mobile carrier support information, device platform support information, mobile application pricing information, mobile application carrier product identifiers, mobile application identifiers, mobile application store identifiers, and other pertinent information. The distribution database 403d also stores the mobile application delivery information comprising, for example, sets of instructions for delivering the mobile applications to the user's mobile device 401. Each of the instructions comprises, for example, delivery uniform resource locators (URLs), alpha-numeric or binary identifiers of the mobile application storefronts, designators of the mobile application storefronts, etc. For purposes of illustration, the detailed description refers to a single distribution database 403d; however, the scope of the computer implemented method and system 400 disclosed herein may be extended to include a network of databases for independent storage of user information, mobile device information, network service information, device platform information, mobile applications, mobile application distribution information, application distribution stock keeping unit (SKU) information, application marketing information, etc.

In an embodiment, the distribution database 403d contains multiple sets of distribution information of a particular mobile application across multiple mobile application storefronts. In another embodiment, the distribution database 403d comprises a lookup table, from where a combination of a mobile device identifier and a mobile application identifier is used to retrieve a distribution record comprising an optional mobile application store identifier or a URL from the distribution database 403d. In another embodiment, the characteristic information, for example, a technology platform identifier, other device capabilities of the mobile device 401 in conjunction with the mobile application identifier, etc., is used to retrieve information stored on the distribution database 403d. The combination of a mobile device 401 and a mobile application identifier and the combination of the characteristic information and mobile application identifier enable prioritization by the availability determination module 403e when determining availability of a mobile application.

The availability determination module 403e determines the availability of one or more mobile applications on the distribution server 403 based on the acquired identification information, the determined network service information, and the determined characteristic information of the user's mobile device 401. The availability determination module 403e determines the availability of one or more mobile applications by indexing the distribution database 403d using, for example, mobile application identifiers, device platforms, and the characteristic information of the mobile device 401. The delivery and messaging engine 403c delivers the reference pointer to the user's mobile device 401 prior to or after the determination of the availability of one or more mobile applications. The availability determination module 403e redirects the user to one or more available mobile applications on the distribution server 403 on determining unavailability of one or more mobile applications on the distribution server 403.

In an embodiment, the interface generation module 403f generates an application interface configurable on multiple device platforms for the user's mobile device 401 using the marketing server 405 and the partner server 407 and publishes the application interface to the marketing server 405. The generated application interface uses the application interface 403g of the distribution server 403 to enable the user to either purchase or download one or more mobile applications or obtain information on one or more mobile applications. For example, the interface generation module 403f automatically generates a set of web pages for one or more mobile applications that can be accessed for differing screen resolutions that first acquire a user's mobile phone number or email address and pass that information to the information acquisition module 403a of the distribution server 403 to begin the mobile application delivery process. The generated web pages also allow for interaction with the distribution server 403 and the transaction management server 404 to provide the user instructions and offer other mobile applications or content and provide direct feedback as to availability of the mobile applications. This set of web pages is also able to request users to opt into receiving more information about other mobile applications and content.

Consider an example where the interface generation module 403f automatically generates SMS short code storefronts using a list of mobile application identifiers for the mobile applications stored in the distribution database 403d. The distribution server 403 implements the SMS short code storefronts by providing a scripted transaction to a transaction module 404a of the transaction management server 404. The scripted transaction receives a notification from an SMSC or MMSC, looks up a mobile application in the distribution database 403d, and then initiates delivery of the reference pointers to the mobile applications to the user's mobile device 401.

The transaction management server 404 comprises a transaction module 404a, a transaction database 404b, a tracking and analysis module 404c, and a script engine 404d, and a user database 404e. The transaction module 404a initiates a mobile application delivery transaction based on the determined network service information and the determined characteristic information of the user's mobile device 401. The mobile application delivery transaction generates a reference pointer for each of the mobile applications. The reference pointer enables the user to perform multiple actions associated with the mobile applications. The tracking and analysis module 404c tracks and analyzes the mobile application delivery transactions, progress of delivery of the reference pointer, and the actions associated with the mobile applications performed by the user. The tracking and analysis module 404c analyzes incoming events and logs for information that will be relevant for analytic tracking of marketing campaigns. The transaction database 404b stores one or more of information obtained from the tracking and the analysis, and one or more transaction scripts associated with mobile application delivery transactions on the transaction management server 404. The transaction database 404b is a relational database of different transaction scripts and records of executions of these scripts. The transaction database 404b also stores information that is used to determine which transaction scripts can be used to perform delivery of the reference pointers for a particular combination of the mobile applications and the mobile device 401 based on the mobile carrier, the device platform, the mobile device model, the device manufacturer, and other pertinent information. For purposes of illustration, the detailed description refers to a single transaction database 404b; however, the scope of the computer implemented method and system 400 disclosed herein may be extended to include a network of databases for independent storage of transaction information, transaction scripts, transaction identifiers, pointers assigned to each of the transactions associated with the mobile applications to track purchase of the mobile applications by the user, etc.

The script engine 404d executes transaction scripts involved in generation of the reference pointer, the delivery of mobile applications, etc. In an embodiment, the script engine 404d also executes transaction scripts involving the marketing of mobile applications to the user. Different scripts are stored into a database of transaction scripts as a part of the transaction database 404b. The user database 404e of the transaction management server 404 comprises sets of users grouped under specific criteria.

Each transaction script is designed to complete a particular system marketing or delivery task to a certain type of mobile device 401 on a certain mobile carrier or network. Transaction scripts can be written in scripting languages, for example, LUA, python, or custom scripting languages. Transaction scripts represent flow through a state machine associated with each complete user-related process, for example, getting to a mobile application download page on a mobile application storefront. Transaction scripts trigger interactions with the user causing the delivery and messaging engine 403c of the distribution server 403 to initiate messaging requests. Transaction scripts can also be put in wait states waiting for an action to complete, for example, an action of waiting for a user to click on a reference pointer or waiting for the MMSC to respond that a message has been delivered. The distribution server 403 interacts with the transaction module 404a to start a high level user interaction such as delivery and provide relevant context information in the form of user references, known and unknown user device information, and the mobile application that is being referenced. The transaction management server 404 has the ability to use the network service information and the characteristic information of the mobile device 401 to index the database 404b of transaction scripts for a specific type of interaction. For example, when delivering a mobile application to an AT&T phone, a transaction script is used that first sends a reference pointer and accounts for the potential that the AT&T phone is able to exclusively use WAP push messages or normal SMS when accessing content links. Alternative transaction scripts can be bound or conditional process shortening can be achieved inside a transaction script when a user and/or the mobile device 401 is known.

The marketing server 405 comprises a marketing module 405a, a marketing database 405c, and a marketing interface 405b. The marketing server 405 stores marketing information associated with one or more mobile applications. The marketing information comprises, for example, tracked and analyzed actions, information obtained from tracking and analysis performed by the transaction management server 404, inputs from a user, and information on the distribution server 403. The marketing module 405a, in communication with the partner server 407 via the network 402, initiates marketing of one or more mobile application. The marketing interface 405b receives input from the user for initiating marketing of mobile applications.

Users interact with the marketing interface 405b in order to initiate different marketing actions. In general, the marketing interface 405b contains a generated server code to serve user interactions with the system 400. The marketing interface 405b is a generated code based on a template for web interaction on and off device for each type of user interaction. These templates comprise templates for requesting a user's phone number, opt-in screens, displaying product information, giving the users instructions for upcoming on-device interactions, displaying related mobile applications, requesting feedback on a mobile application, displaying mobile application information in the form of product pages, displaying mobile storefront category, home pages, etc. These marketing templates are stored in the master marketing database 407d on the partner server 407, filled in via the distribution server 403, and published to the marketing server 405. Automated processes are used to facilitate the generation and publishing of marketing content and interface to the marketing database 405c and the marketing interface 405b of the marketing server 405 based on changes to the master marketing database 407d on the partner server 407 and/or time.

In an embodiment, the marketing interface 405b is used by users of the partner server 407 to cause the marketing module 405a to iterate over lists of opted-in users to perform marketing tasks. In this case as with individual instantiated user interactions, the marketing module 405a communicates with the transaction module 404a of the transaction management server 404 to initiate a transaction script on the transaction management server 404 directly or indirectly to perform a given marketing task such as sending an SMS marketing message, marketing a newly available mobile application from a mobile application publishing partner from whom the user has previously opted in to receive future marketing, etc.

The marketing database 405c is a relational database that stores marketing information relevant for one or more mobile applications. The marketing database 405c stores, for example, one or more mobile application identifiers, marketing images of one or more mobile applications, sample versions of one or more mobile applications, videos, user or editorial reviews, text description of one or more mobile applications, etc. For purposes of illustration, the detailed description refers to a single marketing database 405c; however, the scope of the computer implemented method and system 400 disclosed herein may be extended to include a network of databases for independent storage of marketing information such as mobile application identifiers, marketing images of one or more mobile applications, sample versions of one or more mobile applications, videos, user or editorial reviews, text description of one or more mobile applications transaction information, marketing aliases including short codes, etc.

The mining server 406 comprises a data mining engine 406a, a mining database 406b, and a mining interface 406c. The data mining engine 406a implements internet scraping technology to analyze multiple on-device and online application interfaces to generate and update the distribution database 403d for storing information related to one or more mobile applications. The distribution database 403d stores preferences associated with the mobile applications received from the user for allowing the transaction module 404a on the transaction management server 404 to generate the reference pointer to each of the mobile applications. The data mining engine 406a builds its version of the distribution database 403d in the mining database 406b to support multiple device platforms and mobile carriers. In an embodiment, the mining database 406b and the distribution database 403d are the same database. The data mining engine 406a mimics multiple application interfaces and browsers on the mobile device 401 to precisely determine the availability of the mobile applications, pricing of one or more mobile applications, marketing of one mobile applications, and distribution information.

The data mining engine 406a comprises a scheduler that scrapes WAP or web mobile application storefronts interactively based on priorities of manufactures, models, and mobile applications of the mobile device 401. The scheduler is controlled via the mining interface 406c. The mining interface 406c also allows for direct control of mining operations, inspection of the mining database 406b and mining processes, as well as the ability to manually insert sets of distribution information into the mining database 406b based on selection of one or more mobile applications being targeted for a set of mobile devices 401 specified by combinations of device properties and device carrier information. The mining interface 406c also directs the updating of the distribution database 403d based on updates in the mining database 406b. The mining interface 406c provides differing granularities of updating based on mobile carrier, mobile device information, and the completeness of the mining operation. The mining interface 406c also allows for updating of alias, phone or device, and mobile application information in the mining database 406b. In an embodiment, the transaction management server 404 explicitly sets the user's priorities or determines the user's priorities based on the transaction information and usage statistics. In an embodiment, priorities are tracked in the mining database 406b itself and updated via the mining interface 406c which can be accessed via the partner server 407. The data mining engine 406a uses alias information of the mobile applications stored in the mining database 406b and databases of mobile application storefronts for parsing pertinent marketing, distribution, and aliasing information for the mobile applications. The data mining engine 406a crawls and scrapes the databases of the mobile carriers and the mobile application storefronts for mobile application distribution and marketing information. The data mining engine 406a can be deployed on multiple computer servers, where each of the computer servers run asynchronously and mine specific mobile application storefronts. The data mining engine 406a is deployed on multiple computer servers requires network access on mobile carriers when applicable.

The partner server 407 initiates marketing of one or more mobile applications based on the stored marketing information. The partner server 407 comprises an application marketing configuration module 407a, a campaign deployment and configuration module 407b, a campaign analytics module 407c, a master marketing database 407d, an opt-in user database 407e, an opt-in set management module 407f, and a store configuration module 407g. The application marketing configuration module 407a allows partners to add and configure marketing information for configuring new mobile applications. The application marketing configuration module 407a also allows users of the partner server 407 to associate mobile application aliases that bind mobile application distribution information in the master marketing database 407d to a specific mobile application containing many different product SKUs for different combinations of mobile application storefronts and mobile devices 401. The campaign deployment and configuration module 407b enables launching mobile application marketing campaigns for different marketing venues and provides user's web links, web clients, etc., for example JavaScript, or short code/keyword or QR code graphics that users of the partner server 407 use to market their mobile applications on a given venue. The campaign analytics module 407c analyzes tracked marketing campaigns and transactional data related to a given marketing deployment.

The store configuration module 407g generates an application interface for creating a mobile application storefront configurable on one or more of multiple device platforms. The application interface that creates the mobile application storefront is hosted on the marketing server 405. The application interface enables the user to purchase one or more mobile applications and/or obtain information on the mobile applications. The store configuration module 407g allows users of the partner server 407 to configure a hierarchy of mobile application categories as well as relate mobile applications to be offered as related content. In an embodiment, the store configuration module 407g automatically generates product, category, and home screen web pages that will be hosted on the marketing server 405 for a series of specific mobile applications. These web pages use the mobile application availability information on the distribution database 403d to automatically create mobile application storefronts for each individual mobile device 401 with only supported mobile applications. The web pages can then use the marketing interface 405b of the marketing server 405 to directly request user information and begin the delivery process.

The opt-in set management module 407f allows users of the partner websites to create working sets of opted-in users by mining the user database 404e on the transaction management server 404 for opted-in users who have opted into future marketing during a related marketing campaign. The opt-in user database 407e stores information on the sets of opted-in users as abstract references in the user database 404e.

The distribution server 403, the transaction management server 404, the marketing server 405, and the partner server 407 in communication via the network 402 thereby manage the delivery of the mobile applications to the user's mobile device 401. The mining server 406 is used to update the distribution database 403d used throughout the computer implemented system 400 disclosed herein with either automatic or manually added distribution information. The partner server 407 is used to update mobile application marketing information to start mobile application marketing campaigns, which are then published to the marketing server 405, and to allow for the analysis of those campaigns.

The computer implemented method and system 400 disclosed herein provides closed loop marketing and sales of mobile applications, when the reference pointer to the mobile applications is delivered to the mobile device 401. The transaction management server 404 accomplishes this using a scripted transaction via an SMS message, a WAP PUSH message, an MMS message, or an electronic mail follow-up message that automatically causes the mobile application to request a URL from the distribution server 403. In this embodiment, the mobile application has an included functionality to search incoming messages to look for a transaction identifier. The message contains a transaction identifier that links a mobile application delivery transaction to a particular mobile device number. The transaction identifier could be any alphanumeric transaction identifier, for example, a mobile phone number and the mobile application identifier. This message can be an application-directed SMS that is consumed by the device platform and automatically given to the mobile application upon receipt. This message can also be a typical SMS message that is human readable and contains appropriate information.

A scripted transaction may also be used to contact a mobile carrier or device platform server to query whether or not a mobile application was purchased and downloaded by the user. In an embodiment, the computer implemented system 400 disclosed herein uses a scripted transaction in conjunction with a mobile carrier or a device platform callback system. In this embodiment, the transaction module 404a of the transaction management server 404 uses a direct network based interface or an indirect interface through the application interface 403g of the distribution server 403 to inform a mobile carrier, mobile application storefront, or other third party mobile application hosting provider, of a transaction identifier either separately or in conjunction with the user's mobile device 401 to the mobile application storefront. The mobile application storefront is then able to use the application interface 403g on the distribution server 403 to accept a completion event or another event relative to tracking a user's behavior. The transaction identifier, which may be a unique transaction identifier or other user identifier is passed as part of the tracking request to the application interface 403g, which then passes the information back to the transaction management server 404. In this way, the transaction management server 404 can track events that happen on external servers such as mobile application storefronts to be able to track closed-loop downloads or sales of applications once they have been delivered by the computer implemented system 400 disclosed herein.

The computer implemented system 400 disclosed herein also performs database flattening for the mining database 406b, the distribution database 403d, the transaction database 404b, the user database 404e, the marketing database 405c, etc. In this context, database flattening involves the removal of conditional checking when accessing one of the databases, for example 406b, 403d, 404b, 404e, 405c, etc., by changing the database format to be accessible via a simple indexing scheme rather than a complicated search query. Databases that have simple and known accessors can be flattened, for example, by using their accessing keys as a computer file system file and directory names and encoding the looked up value inside of the file. For example, mobile application availability of a given mobile application on a given mobile device 401 can be represented by encoding the mobile application identifier as a directory name. In each file system directory for a mobile application, exists a list of other directories where each directory is named for a supported mobile device 401. Inside each directory for a supported mobile device 401 for a mobile application, exists be a file for each supported mobile application storefront where each mobile application storefront file contains the information required to be able to deliver the mobile application on the mobile application storefront to the mobile device 401. Using this system, incoming requests for mobile applications or availability can be handled by the formation of a file system and file name based on simple string concatenation rather than via a MySQL or Oracle database query. The computer implemented system 400 disclosed herein uses this concept to be able to separate out front-end components that require heavy server interaction such as marketing client queries on application availability.

Database flattening allows use of a computer's file system to directly access records or tables of the databases, for example, 406b, 403d, 404b, 404e, 405c, etc., without other software. For example, consider the MySQL database where each record consists of an application name and a list of mobile devices 401 which a mobile application are to run. In the computer implemented method and system 400 disclosed herein, an equivalent set of files are created on the computer where there is one file for each mobile application that contains a text list of mobile device names. The computer implemented system 400 disclosed herein provides, for example, WAP or web templates based on the flattened databases. These templates are customized via style sheets to create mobile application storefronts.

The messaging server 408 is in communication with the distribution server 403, the marketing server 405, and the transaction management server 404, via the network 402. The messaging server 408, for example, the SMSC messaging server, the MMSC messaging server, electronic mail servers, etc., transmits messages to the mobile device 401 via the distribution server 403. The delivery and messaging engine 403c of the distribution server 403 transmits one or more messages to the user's mobile device 401 via the messaging server 408 for re-initiating delivery of one or more mobile applications and requesting feedback on the delivery and quality of the mobile applications. The messaging servers 408 can be third party servers that have access to mobile carriers capable of delivering SMS/MMS messages directly to the user' mobile device 401. In an embodiment, external electronic mail servers deliver electronic mail to the user's mobile device 401.

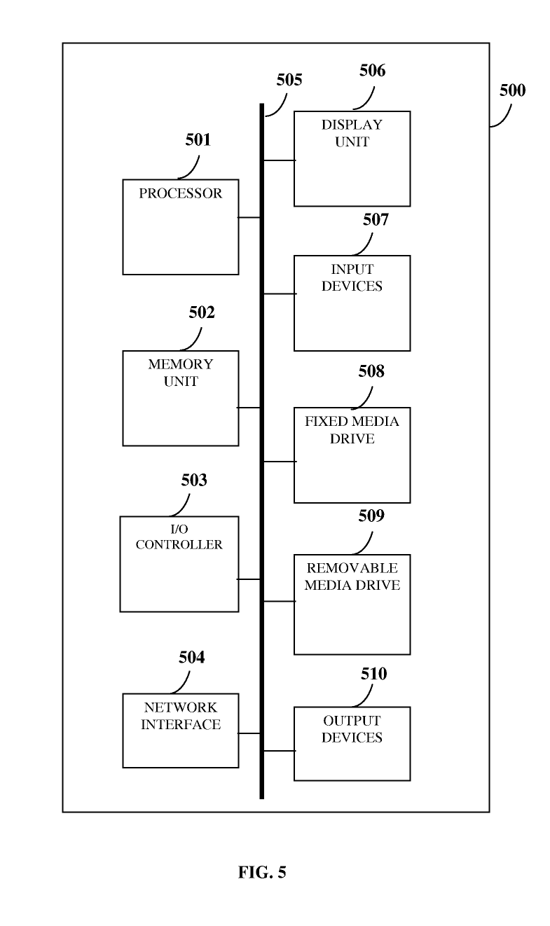

FIG. 5 exemplarily illustrates the architecture of a computer system 500 employed for managing delivery of one or more mobile applications to a mobile device 401 of a user. The distribution server 403, the transaction management server 404, the marketing server 405, the mining server 406, and the partner server 407 employ the architecture of the computer system 500 exemplarily illustrated in FIG. 5.

The distribution server 403 communicates with the transaction management server 404, the marketing server 405, the partner server 407, the mining server 406, and the messaging servers 408 via a network 402, for example, a short range network or a long range network. The network 402 is, for example, a local area network (LAN), a wide area network, a mobile communication network, etc. The computer system 500 comprises, for example, a processor 501, a memory unit 502 for storing programs and data, an input/output (I/O) controller 503, a network interface 504, a data bus 505, a display unit 506, input devices 507, a fixed media drive 508, a removable media drive 509, output devices 510 such as a printer, etc.

The processor 501 is an electronic circuit that can execute computer programs. The memory unit 502 is used for storing programs, applications, and data. For example, the modules of the distribution server 403, the transaction management server 404, the mining server 406, the marketing server 405, and the partner server 407 are stored on the memory unit 502 of each respective computer system 500. The memory unit 502 is, for example, a random access memory (RAM) or another type of dynamic storage device that stores information and instructions for execution by the processor 501. The memory unit 502 also stores temporary variables and other intermediate information used during execution of the instructions by the processor 501. The computer system 500 further comprises a read only memory (ROM) or another type of static storage device that stores static information and instructions for the processor 501. The network interface 504 enables connection of the computer system 500 of each of the distribution server 403, the transaction management server 404, the mining server 406, the marketing server 405, and the partner server 407 to the network 402. The computer system 500 communicates with other computer systems, for example, through the network interface 504. The network interface 504 is, for example, a Bluetooth™ interface, an infrared (IR) interface, a WiFi interface, a universal serial bus interface (USB), a local area network (LAN) interface, or a wide area network (WAN) interface, etc.

The I/O controller 503 controls the input and output actions performed by the user 401. The data bus 505 permits communication between the modules, for example, 403a, 403b, 403c, 403d, 403e, 403f, and 403g of the distribution server 403. The data bus 505 also permits communication between the modules, for example, 404a, 404b, 404c, 404d, and 404e of the transaction management server 404. The data bus 505 also permits communication between the modules, for example, 405a, 405b, and 405c of the marketing server 405. The data bus 505 also permits communication between the modules, for example, 406a, 406b, and 406c of the mining server 406. The data bus 505 also permits communication between the modules, for example, 407a, 407b, 407c, 407d, 407e, 407f, and 407g of the partner server 407.

The display unit 506 displays, via the application interface 403g, and the marketing interface 405b, the results computed by the distribution server 403, the transaction management server 404, the marketing server 405, and the partner server 407 to the user 401. The input devices 507 are used for inputting data into the computer system 500. The input devices 507 are, for example, a keyboard such as an alphanumeric keyboard, a joystick, a mouse, a touch pad, a light pen, etc.

The computer system 500 further comprises a fixed media drive 508 and a removable media drive 509 for receiving removable media. Computer applications and programs are used for operating the computer system 500. The programs are loaded onto the fixed media drive 508 and into the memory unit 502 of the computer system 500 via the removable media drive 509. In an embodiment, the computer applications and programs may be loaded directly through the network 402. Computer applications and programs are executed by double clicking a related icon displayed on the display unit 506 using one of the input devices 507. The user interacts with the computer implemented system 400 disclosed herein using, for example, the application interface 403g and the marketing interface 405b provided on the user's mobile device 401. The application interface 403g and the marketing interface 405b are hosted on the distribution server 403 and the marketing server 405. In an embodiment, the marketing interface 405b may be plugged-in to the user's mobile device 401.

The computer system 500 employs operating systems for performing multiple tasks. An operating system is responsible for the management and coordination of activities and the sharing of the resources of the computer system 500. The operating system further manages security of the computer system 500, peripheral devices connected to the computer system 500, and network connections. The operating system employed on the computer system 500 recognizes, for example, inputs provided by the user using one of the input devices 507, the output display, files and directories stored locally on the fixed media drive 508, etc. The operating system on the computer system 500 of the mobile device 401 executes different programs initiated by the user using the processor 501. Each respective processor 501 retrieves instructions for executing the modules 403a, 403b, 403c, 403d, 403e, 403f, and 403g of the distribution server 403, the modules 404a, 404b, 404c, 404d, and 404e of the transaction management server 404, the modules 405a, 405b, and 405c of the marketing server 405, the modules 406a, 406b, and 406c of the mining server 406, and the modules 407a, 407b, 407c, 407d, 407e, 407f, and 407g of the partner server 407 from the respective program memory in the form of signals. A program counter determines the location of the instructions in the program memory. The program counter stores a number that identifies the current position in the program of each of the modules 403a, 403b, 403c, 403d, 403e, 403f, and 403g of the distribution server 403, the modules 404a, 404b, 404c, 404d, and 404e of the transaction management server 404, the modules 405a, 405b, and 405c of the marketing server 405, the modules 406a, 406b, and 406c of the mining server 406, and the modules 407a, 407b, 407c, 407d, 407e, 407f, and 407g of the partner server 407.

The instructions fetched by the processor 501 from the program memory after being processed are decoded. After processing and decoding, the processor 501 executes the instructions. For example, the information acquisition module 403a of the distribution server 403 defines instructions for acquiring identification information of the user's mobile device 401 and one or more mobile applications. The information determination module 403b defines instructions for determining network service information and characteristic information of the mobile device 401 based on the acquired identification information. The delivery and messaging engine 403c defines instructions for delivering a reference pointer to each of the mobile applications to the user's mobile device 401 based on one or more of the determined network service information and the determined characteristic information of the mobile device 401. The availability determination module 403e defines instructions for determining the availability of one or more mobile applications on the distribution server 403 based on the acquired identification information, the determined network service information, and the determined characteristic information of the mobile device 401. The delivery and messaging engine 403c defines instructions for transmitting one or more messages to the user's mobile device 401 for reinitiating delivery of one or more mobile applications and for requesting feedback on the delivery and quality of one or more mobile applications.

The transaction module 404a of the transaction management server 404 defines instructions for initiating mobile application delivery transactions associated with one or more mobile applications based on the determined network service information and the determined characteristic information of the mobile device 401. The tracking and analysis module 404c defines instructions for tracking and analyzing the mobile application delivery transactions, the progress of the delivery of the reference pointers, and the actions associated with the mobile applications performed by the user. The script engine 404d defines instructions for executing transaction scripts involved in the generation of the reference pointers, transaction scripts involved in the delivery of mobile applications and transaction scripts involving the marketing of a mobile application to a user.

The marketing module 405a of the marketing server 405 defines instructions for initiating marketing of one or more mobile applications based on transaction information, inputs from the user, and information on the distribution server 403. The marketing interface 405b defines instructions for enabling a user to provide user input to initiate marketing of the mobile applications.

The data mining engine 406a of the mining server 406 defines instructions for using internet scraping technology to analyze multiple on-device and online application interfaces to generate and update the distribution database 403d for storing information related to one or more mobile applications. The mining interface 406c of the mining server 406 defines instructions for directing the updating of the distribution database 403d based on updates in the mining database 406b.

The application marketing configuration module 407a of the partner server 407 defines instructions for allowing partners to add and configure marketing information for mobile applications. The campaign deployment and configuration module 407b of the partner server 407 defines instructions for enabling launching of mobile application marketing campaigns for different marketing venues. The campaign analytics module 407c of the partner server 407 defines instructions for analyzing transactional data related to a given marketing deployment. The opt-in set management module 407f of the partner server 407 defines instructions for allowing users of the partner websites to create working sets of opted-in users. The store configuration module 407g of the partner server 407 defines instructions for generating an application interface for creating a mobile application storefront configurable on multiple device platforms and hosted on the marketing server 405. The defined instructions are stored in the program memory or received from a remote server.

The processor 501 of the distribution server 403 retrieves the instructions defined by the information acquisition module 403a, the information determination module 403b, the delivery and messaging engine 403c, and the availability determination module 403e, and executes the instructions. The processor 501 of the transaction management server 404 retrieves the instructions defined by the transaction module 404a, the tracking and analysis module 404c, and the script engine 404d and executes the instructions. The processor 501 of the marketing server 405 retrieves the instructions defined by the marketing module 405a and the marketing interface 405b and executes the instructions. The processor 501 of the mining server 406 retrieves the instructions defined by the data mining engine 406a and the mining interface 406c and executes the instructions. The processor 501 of the partner server 407 retrieves the instructions defined by the application marketing configuration module 407a, the campaign deployment and configuration module 407b, the campaign analytics module 407c, the opt-in set management module 407f, and the store configuration module 407g and executes the instructions.

At the time of execution, the instructions stored in the instruction register are examined to determine the operations to be performed. The operations include arithmetic and logic operations. The processor 501 then performs the specified operation. The operating system performs multiple routines for performing a number of tasks required to assign the input devices 507, the output devices 510, and memory for execution of the modules, etc., of the computer implemented system 400 disclosed herein. The tasks performed by the operating system comprise assigning memory to the modules of the computer implemented system 400 and data, moving data between the memory unit 502 and disk units and handling input/output operations. The operating system performs the tasks, on request, by the operations and after performing the tasks, the operating system transfers the execution control back to the processor 501. The processor 501 continues the execution to obtain one or more outputs. The outputs of the execution of the modules of the computer implemented system 400 are displayed to the user.

Disclosed herein is also a computer program product comprising computer executable instructions embodied in a non-transitory computer readable storage medium. As used herein, the term “non-transitory computer readable storage medium” refers to all computer readable media, for example, non-volatile media such as optical disks or magnetic disks, volatile media such as a register memory, a processor cache, etc., and transmission media such as wires that constitute a system bus coupled to the processor 501, except for a transitory, propagating signal.

The computer program product disclosed herein comprises multiple computer program codes for managing delivery of one or more mobile applications to a mobile device 401 of a user. For example, the computer program product disclosed herein comprises a first computer program code for acquiring identification information of the user's mobile device 401 and one or more mobile applications by the distribution server 403; a second computer program code for determining network service information and characteristic information of the user's mobile device 401 based on the acquired identification information; a third computer program code for allowing the transaction management server 404 to initiate a mobile application delivery transaction based on the determined network service information and the determined characteristic information of the user's mobile device 401, where the mobile application delivery transaction generates a reference pointer to each of the mobile applications; a fourth computer program code for delivering the reference pointer to each of the mobile applications to the user's mobile device 401 based on the determined network service information and/or the determined characteristic information of the user's mobile device 401, where the reference pointer enables the user to perform actions associated with each of the mobile applications. The computer program product disclosed herein further comprises additional computer program codes for performing additional steps that may be required and contemplated for managing delivery of one or more mobile applications to the user's mobile device 401.

The computer program codes comprising the computer executable instructions are embodied on the non-transitory computer readable storage medium. The processor 501 of the computer system 500 retrieves these computer executable instructions and executes them. When the computer executable instructions embodied on the non-transitory computer readable storage medium are executed by the processor 501, the computer executable instructions cause the processor 501 to perform the method steps for managing delivery of one or more mobile applications to the user's mobile device 401. In an embodiment, a single piece of computer program code comprising computer executable instructions performs one or more steps of the computer implemented method disclosed herein for managing delivery of one or more mobile applications to the user's mobile device 401.

For purposes of illustration, the detailed description refers to the servers, for example, 403, 404, 405, 406, and 407 being run locally on a computer system 500; however the scope of the computer implemented method and system 400 disclosed herein is not limited to the servers, for example, 403, 404, 405, 406, and 407 being run locally on the computer system 500 via the operating system and the processor 501 but may be extended to run remotely over the network 402, for example, by employing a web browser and a remote server, a mobile phone, or other electronic devices.

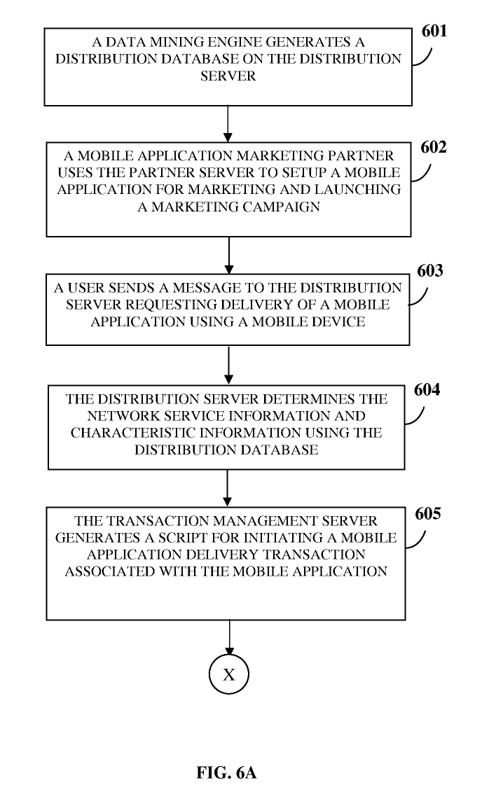

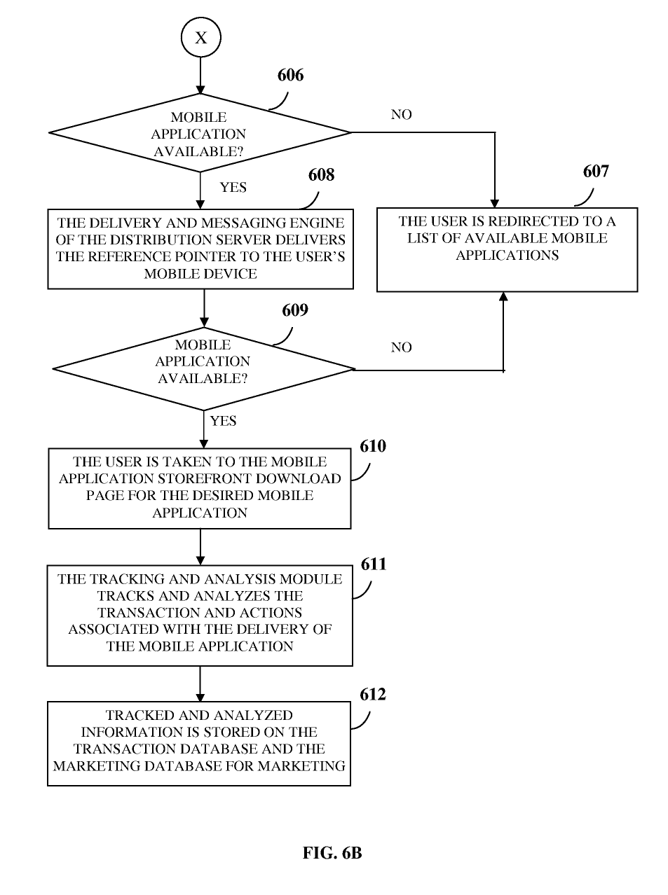

FIGS. 6A-6B exemplarily illustrate a flow chart comprising the steps for managing delivery of one or more mobile applications to a mobile device 401 of a user. The data mining engine 406a of the mining server 406 generates 601 the distribution database 403d on the distribution server 403 by using internet scraping technology to analyze multiple application interfaces and store information related to one or more mobile applications in the distribution database 403d. The data mining engine 406a communicates with mobile carriers, publisher storefronts, and platform storefronts for generating the distribution database 403d. A mobile application marketing partner uses 602 the partner server 407 to setup a mobile application for marketing and launching a marketing campaign. A user sends 603 an SMS message to the distribution server 403 requesting delivery of a mobile application, for example, a gaming application using the mobile device 401. The distribution server 403 acquires the mobile device number from the SMS message and the mobile application identifier of the gaming application using information stored in the distribution database 403d or other databases that store the mobile applications, the application store keeping units, etc.

The distribution server 403 determines 604 the network service information and the characteristic information of the mobile device 401, for example, the mobile carrier, manufacturer and model of the mobile device 401 if possible using the distribution database 403d. For example, the information determination module 403b of the distribution server 403 can request available information from the MMSC or SMSC messaging servers 408. The transaction management server 404 generates 605 a transaction script associated with delivery of the mobile application herein referred to as the “gaming application”, using the script engine 404d for initiating a mobile application delivery transaction associated with the gaming application. The availability determination module 403e determines 606 availability of the gaming application on the distribution server 403 by querying the distribution database 403d on the distribution server 403 based on known information about the user's mobile device 401. If the gaming application is unavailable, the user is redirected 607 to a list of available mobile applications on the distribution server 403. If the gaming application is available, then delivery and messaging engine 403c of the distribution server 403 delivers 608 the reference pointer to the gaming application to the user's mobile device 401. For example, the delivery and messaging engine 403c delivers an abstract URL reference to the game to the user's mobile device 401. When the user's mobile device 401 receives the reference pointer, the device information is deterministically determined automatically or upon the user opening the URL reference. A final check on the availability of the application availability for the user's mobile device 401 is performed 609. If the gaming application is not available, the user is redirected 607 to the list of available mobile applications. If the gaming application is available, the user is taken 610 to the mobile application storefront download page for that gaming application. The tracking and analysis module 404c tracks and analyzes 611 the transactions and actions associated with the delivery of the gaming application. For example, the tracking and analysis module 404c tracks the user's name, the user's mobile phone number, the transaction script generated, the network service information, and the characteristic information of the user's mobile device 401 and stores 612 the transaction information in the transaction database 404b and the marketing database 405c for marketing and campaign management.

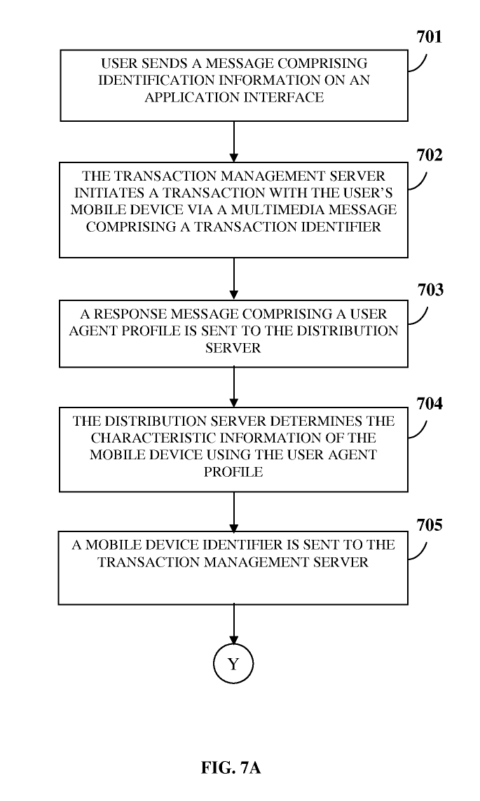

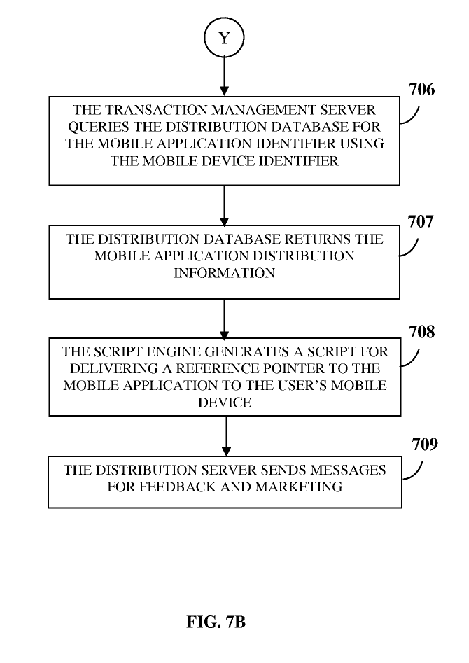

FIGS. 7A-7B exemplarily illustrate a flow chart comprising the steps for delivering a reference pointer to each of one or more mobile applications to a mobile device 401 of a user and for initiating marketing. The user sends 701a message comprising identification information, for example, a mobile device number and a mobile application identifier of a mobile application on an application interface on a user's mobile device 401. The transaction management server 404 initiates 702 a transaction with the user's mobile device 401 via a multimedia message. The multimedia message comprises a transaction identifier. The transaction identifier identifies events and actions related to a particular scripted transaction. The transaction identifier allows each incoming event or request to be mapped to an ongoing scripted transaction such as a transaction involving the delivery of the reference pointer. A response message comprising the user agent profile is sent 703 via the application interface on the user's mobile device 401 to the distribution server 403. As disclosed herein, the term “user agent profile” refers to a profile name given to each mobile device 401 for unique identification of the mobile device 401. In an embodiment, the identifier is passed back to the MMSC messaging server 408 to allow the network service providers to properly identify the characteristics of the mobile device 401 for delivering properly formatted content to the mobile device 401.

The distribution server 403 determines 704 characteristic information comprising the manufacturer and model of the mobile device 401 using the user agent profile by querying the distribution database 403d on the distribution server 403. The distribution server 403 sends 705 the mobile device identifier to the transaction management server 404. The transaction management server 404 queries 706 the distribution database 403d for the mobile application identifier using the mobile device identifier. The distribution database 403d returns 707 the mobile application distribution information to the transaction management server 404. The script engine 404d on the transaction management server 404 generates 708 a script for delivering a reference pointer to the mobile application to the user's mobile device 401. In an embodiment, only a single reference pointer or link is sent to the mobile device 401 that both identifies the mobile device 401 and then automatically redirects the user to the purchase screen or related content if the mobile application is not available. The distribution server 403 delivers the reference pointer to the mobile application to the user's mobile device 401. Thereafter, the distribution server 403 sends 709 messages for feedback and marketing.

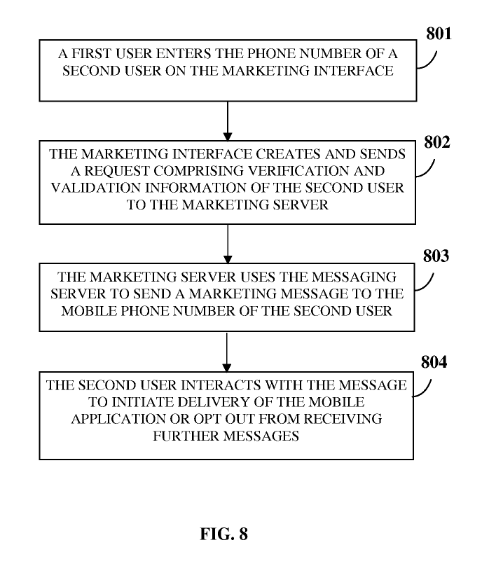

FIG. 8 exemplarily illustrates a flow chart comprising the steps for initiating marketing of a mobile application via a marketing server 405. The first user enters 801 a mobile phone number of a second user on the marketing interface 405b hosted by the marketing server 405. The marketing interface 405b creates and sends 802 a request comprising verification and validation information of the second user to the marketing server 405 via the messaging server 408. For example, the marketing server 405 verifies if the mobile number of the second user is a valid number. The marketing server 405 uses 803 the messaging server 408 and the mobile phone number of the second user to send a marketing message comprising, for example, referral text, the mobile application identifier such as a code of the mobile application to initiate delivery of the mobile application to the second user. The second user interacts 804 with the message to either initiate delivery of the mobile application, purchase the mobile application, or opt out from receiving further messages. For example, the second user may reply back with a message “YES” to initiate delivery of the mobile application and a message “NO” to opt out from receiving further messages.

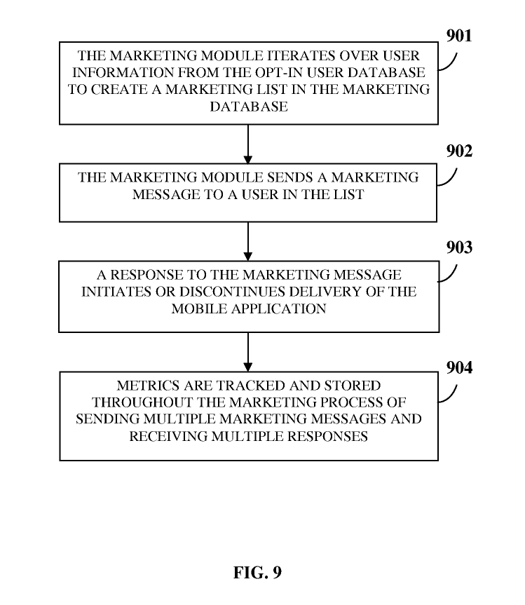

FIG. 9 exemplarily illustrates a flow chart comprising the steps for initiating marketing of a mobile application to a list of users via the marketing server 405. The marketing module 405a on the marketing server 405 iterates 901 over the user information from the opt-in user database 407e to create a list of users herein referred to as a “marketing list” in the marketing database 405c. The users on the marketing list are identified based on the user information, for example, users having purchased mobile applications, users in a certain age group having mobile devices 401 compatible with the available applications, etc. The marketing module 405a sends 902 a marketing message comprising referral text and a mobile application link to the user on the marketing list. The user responds with a “YES” or a “NO” message to initiate or discontinue 903 delivery of the mobile application. Metrics, for example, the user's mobile number, the response from the user, the keys pressed by the user, etc., are tracked and stored 904 on the marketing server 405 throughout the marketing process of sending marketing messages and the process of delivery of the mobile application.

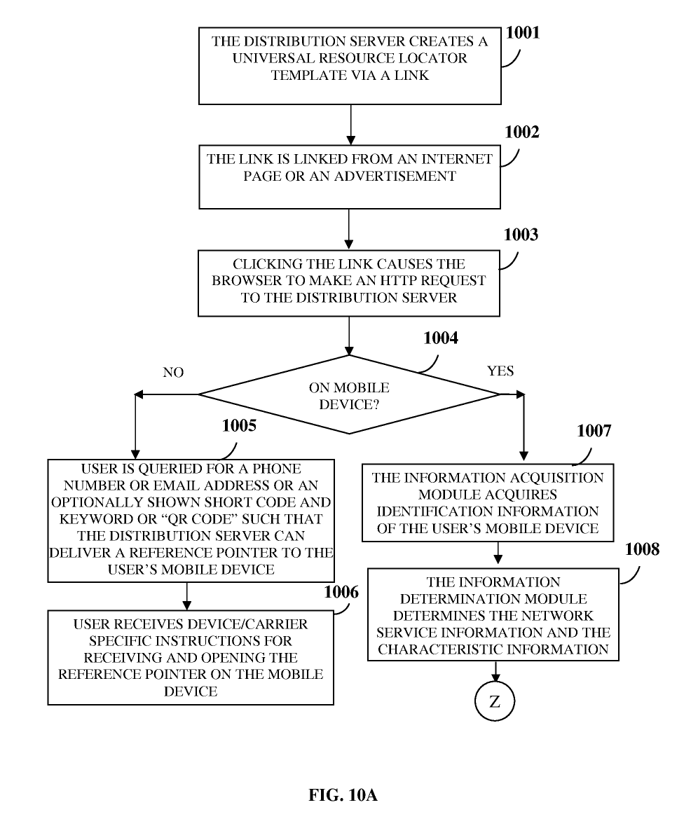

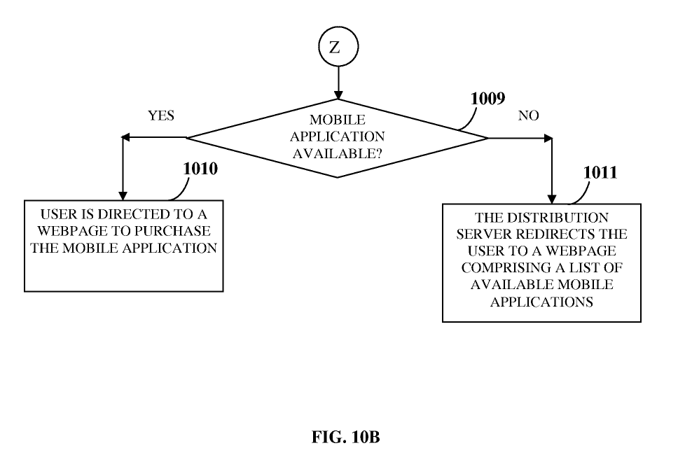

FIGS. 10A-10B exemplarily illustrate a flow chart comprising the steps for managing delivery of one or more mobile applications to a mobile device 401 of a user using a single reference pointer. The distribution server 403 creates 1001 a URL template in the form of a single reference pointer herein referred to as a “link”. The link is directly linked 1002 from internet pages or internet advertisements, for example, text or image search advertisements. The link directs the user to a web page that requests the user to enter a mobile phone number. When clicked, the link causes 1003 the browser on the mobile device 401, a personal computer or other web-enabled device to make an HTTP request to the distribution server 403, where the part of the link itself comprises the mobile application identifier. The distribution server 403 then determines 1004 whether or not the user is clicking from a supported mobile device 401. If the user is not accessing the link from a supported mobile device 401, then the user is queried 1005 for a mobile phone number or an electronic mail address or an optionally shown short code and keyword, or “QR” code, such that the distribution server 403 can deliver the reference pointer to the mobile application to the user's mobile device 401. The user receives 1006 mobile device or mobile carrier specific instructions for receiving and opening the reference pointer on the user's mobile device 401. If the user is accessing the link from a supported mobile device 401, then the information acquisition module 403a acquires 1007 the identification information comprising, for example, mobile browser profile strings, mobile browser cookies, mobile subscriber identifiers, previous user identifiers from a delivery system, etc.

The information determination module 403b determines 1008 the network service information and the characteristic information via a query to the distribution server 403. The distribution server 403 utilizes the identification information, the network service information, and the characteristic information to query the distribution database 403d for information on the mobile application. The availability determination module 403e determines 1009 availability of the mobile application. If the mobile application is available, the user is directed 1010 to a web page to purchase the mobile application. If the mobile application is unavailable, the distribution server 403 redirects 1011 the user to a web page comprising a list of available mobile applications.

It will be readily apparent that the various methods and algorithms disclosed herein may be implemented on computer readable media appropriately programmed for general purpose computers and computing devices. As used herein, the term “computer readable media” refers to non-transitory computer readable media that participate in providing data, for example, instructions that may be read by a computer, a processor or a like device. Non-transitory computer readable media comprise all computer readable media, for example, non-volatile media, volatile media, and transmission media, except for a transitory, propagating signal. Non-volatile media comprise, for example, optical disks or magnetic disks and other persistent memory volatile media including a dynamic random access memory (DRAM), which typically constitutes the main memory. Volatile media comprise, for example, a register memory, processor cache, a random access memory (RAM), etc. Transmission media comprise, for example, coaxial cables, copper wire and fiber optics, including the wires that constitute a system bus coupled to a processor. Common forms of computer readable media comprise, for example, a floppy disk, a flexible disk, hard disk, magnetic tape, any other magnetic medium, a compact disc-read only memory (CD-ROM), digital versatile disc (DVD), any other optical medium, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read. A “processor” refers to any one or more microprocessors, central processing unit (CPU) devices, computing devices, microcontrollers, digital signal processors or like devices. Typically, a processor receives instructions from a memory or like device, and executes those instructions, thereby performing one or more processes defined by those instructions. Further, programs that implement such methods and algorithms may be stored and transmitted using a variety of media, for example, the computer readable media in a number of manners. In an embodiment, hard-wired circuitry or custom hardware may be used in place of, or in combination with, software instructions for implementation of the processes of various embodiments. Thus, embodiments are not limited to any specific combination of hardware and software. In general, the computer program codes comprising computer executable instructions may be implemented in any programming language. Some examples of languages that can be used comprise C, C++, C#, Perl, Python, or JAVA. The computer program codes or software programs may be stored on or in one or more mediums as an object code. The computer program product disclosed herein comprises computer executable instructions embodied in a non-transitory computer readable storage medium, wherein the computer program product comprises computer program codes for implementing the processes of various embodiments.

Where databases are described such as the distribution database 403d, the transaction database 404b, the user database 404e, the marketing database 405c, the mining database 406b, the master marketing database 407d, and the opt-in user database 407e, it will be understood by one of ordinary skill in the art that (i) alternative database structures to those described may be readily employed, and (ii) other memory structures besides databases may be readily employed. Any illustrations or descriptions of any sample databases disclosed herein are illustrative arrangements for stored representations of information. Any number of other arrangements may be employed besides those suggested by tables illustrated in the drawings or elsewhere. Similarly, any illustrated entries of the databases represent exemplary information only; one of ordinary skill in the art will understand that the number and content of the entries can be different from those disclosed herein. Further, despite any depiction of the databases as tables, other formats including relational databases, object-based models, and/or distributed databases may be used to store and manipulate the data types disclosed herein. Likewise, object methods or behaviors of a database can be used to implement various processes, such as those disclosed herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, a local area network (LAN), a wide area network (WAN) or the Ethernet, token ring, or via any appropriate communication means or combination of communication means. Each of the devices may comprise computers such as those based on the Intel® processors, AMD® processors, UltraSPARC® processors, Sun® processors, IBM® processors, etc., that are adapted to communicate with the computer. Any number and type of machines may be in communication with the computer.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

We claim:

1. A computer implemented method for managing delivery of one or more mobile applications to a mobile device of a user, comprising:
providing a distribution server in communication with a transaction management server via a network;
acquiring identification information of said mobile device of said user and said one or more mobile applications by said distribution server;
determining network service information and characteristic information of said mobile device based on said acquired identification information by said distribution server;
initiating a mobile application delivery transaction by said transaction management server, in communication with said distribution server, based on said determined network service information and said determined characteristic information of said mobile device, wherein said mobile application delivery transaction generates a reference pointer for each of said one or more mobile applications; and
delivering said reference pointer to said each of said one or more mobile applications to said mobile device of said user by said distribution server based on one or more of said determined network service information and said determined characteristic information of said mobile device, wherein said reference pointer enables said user to perform actions associated with said each of said one or more mobile applications;
whereby said distribution server communicates with said transaction management server via said network for managing said delivery of said one or more mobile applications to said mobile device of said user.

2. The computer implemented method of claim 1, further comprising providing a mining server for generating and updating a distribution database in said distribution server with information related to said one or more mobile applications.

3. The computer implemented method of claim 1, wherein said identification information comprises a mobile number associated with said mobile device, and one or more of an alphanumeric string, a binary value, and a hex string uniquely identifying said one or more mobile applications.

4. The computer implemented method of claim 1, wherein said identification information is acquired from one of said mobile device of said user, said distribution server, and external marketing parties via a plurality of input modes and messaging modes.

5. The computer implemented method of claim 1, further comprising determining availability of said one or more mobile applications on said distribution server based on said acquired identification information, said determined network service information, and said determined characteristic information of said mobile device, wherein said reference pointer is delivered to said mobile device of said user prior to or after said determination of said availability of said one or more mobile applications on said distribution server.

6. The computer implemented method of claim 5, wherein said distribution server redirects said user to one or more available mobile applications on said distribution server, on determining unavailability of said one or more mobile applications on said distribution server.

7. The computer implemented method of claim 1, further comprising tracking and analyzing said mobile application delivery transaction, progress of said delivery of said reference pointer, and said actions associated with said one or more mobile applications performed by said user, by said transaction management server, and storing information obtained from said tracking and said analysis, inputs from said user, and information on said distribution server, on said transaction management server and a marketing server via said network.

8. The computer implemented method of claim 7, further comprising providing a partner server that communicates with one or more of said transaction management server, a marketing server, and said distribution server via said network for initiating marketing of one or more of a plurality of mobile applications based said stored information.

9. The computer implemented method of claim 1, wherein said determination of said network service information and said characteristic information of said mobile device is performed using one of an input from said user, a message from said user, and a query to said distribution server.

10. The computer implemented method of claim 1, further comprising transmitting one or more messages to said mobile device of said user by said distribution server for performing one or more of:
reinitiating said delivery of said one or more mobile applications; and
requesting feedback on said delivery and quality of said one or more mobile applications.

11. The computer implemented method of claim 1, further comprising assigning a pointer to each of said actions associated with said one or more mobile applications by said transaction management server to track purchase of said one or more mobile applications by said user.

12. The computer implemented method of claim 1, further comprising configuring said reference pointer to said one or more mobile applications by said distribution server based on said acquired identification information, and said determined network service information and said determined characteristic information of said mobile device.

13. The computer implemented method of claim 1, wherein said delivery of said reference pointer to said mobile device is performed via a messaging mode.

14. The computer implemented method of claim 1, further comprising determining mode of said delivery of said reference pointer by said distribution server using said determined network service information, said determined characteristic information, and device platform of said mobile device.

15. The computer implemented method of claim 1, wherein said delivery of said reference pointer to said mobile device is performed across a plurality of device platforms, a plurality of application interfaces, a plurality of network services, and a plurality of characteristics of said mobile device.

16. The computer implemented method of claim 1, further comprising receiving preferences associated with said one or more mobile applications from said user by said distribution server and storing said preferences on said distribution server for said generation of said reference pointer to each of said one or more mobile applications by said transaction management server.

17. A computer implemented method for managing delivery of one or more mobile applications to a mobile device of a user, comprising:
providing a distribution server in communication with a transaction management server, a marketing server, and a partner server via a network;
acquiring identification information of said mobile device of said user and said one or more mobile applications by said distribution server;
determining network service information and characteristic information of said mobile device based on said acquired identification information by said distribution server;
initiating a mobile application delivery transaction by said transaction management server, in communication with said distribution server, based on said determined network service information and said determined characteristic information of said mobile device, wherein said mobile application delivery transaction generates a reference pointer to each of said one or more mobile applications;
delivering said reference pointer to said each of said one or more mobile applications to said mobile device of said user by said distribution server based on one or more of said determined network service information and said determined characteristic information of said mobile device, wherein said reference pointer enables said user to perform actions associated with said each of said one or more mobile applications;
tracking and analyzing said mobile application delivery transaction, progress of said delivery of said reference pointer, and said actions associated with said one or more mobile applications performed by said user, by said transaction management server, and storing information obtained from said tracking and said analysis on said transaction management server and said marketing server via said network;
storing marketing information of said one or more mobile applications on said marketing server, wherein said marketing information comprises said information obtained from said tracking and said analysis, inputs from said user, and information on said distribution server; and
initiating marketing of one or more of a plurality of mobile applications by said partner server, in communication with one or more of said marketing server, said transaction management server, and said distribution server, based on said stored marketing information;
whereby said distribution server, said transaction management server, said marketing server, and said partner server in communication via said network manage said delivery of said one or more mobile applications to said mobile device of said user.

18. The computer implemented method of claim 17, further comprising providing a marketing interface for receiving inputs from said user for said initiation of said marketing of said one or more mobile applications.

19. The computer implemented method of claim 17, further comprising generating an application interface for creating a mobile application storefront configurable on one or more of a plurality of device platforms by said partner server and hosted on said marketing server, wherein said application interface enables said user to one of purchase said one or more mobile applications and obtain information on said one or more mobile applications.

20. The computer implemented method of claim 17, further comprising providing access of said transaction management server, said distribution server, and said marketing server to one or more external marketing parties for said marketing of said one or more mobile applications.

21. A computer implemented system for managing delivery of one or more mobile applications to a mobile device of a user, comprising:
a distribution server comprising:
an information acquisition module that acquires identification information of said mobile device of said user and said one or more mobile applications;
an information determination module that determines network service information and characteristic information of said mobile device based on said acquired identification information; and
a delivery and messaging engine that delivers a reference pointer to each of said one or more mobile applications to said mobile device of said user based on one or more of said determined network service information and said determined characteristic information of said mobile device; and
a transaction management server in communication with said distribution server via a network, wherein said transaction management server comprises:
a transaction module that initiates a mobile application delivery transaction based on said determined network service information and said determined characteristic information of said mobile device, wherein said mobile application delivery transaction generates said reference pointer for said each of said one or more mobile applications, wherein said reference pointer enables said user to perform actions associated with said each of said one or more mobile applications;
whereby said distribution server communicates with said transaction management server via said network to manage said delivery of said one or more mobile applications to said mobile device of said user.

22. The computer implemented system of claim 21, wherein said transaction management server further comprises a tracking and analysis module that tracks and analyzes said mobile application delivery transaction, progress of said delivery of said reference pointer, and said actions associated with said one or more mobile applications performed by said user.

23. The computer implemented system of claim 22, wherein said transaction management server further comprises a transaction database, in communication with said tracking and analysis module, that stores one or more of information on said tracking and said analysis and one or more transaction scripts associated with mobile application delivery transactions on said transaction management server.

24. The computer implemented system of claim 21, further comprising a marketing server in communication with said transaction management server and said distribution server via said network, wherein said marketing server stores marketing information of said one or more mobile applications in a marketing database, wherein said marketing information comprises information obtained from tracking and analysis performed by said transaction management server, inputs from said user, and information on said distribution server.

25. The computer implemented system of claim 24, further comprising a partner server in communication with one or more of said transaction management server, said distribution server, and said marketing server via said network, wherein said partner server initiates marketing of one or more of a plurality of mobile applications based on said stored marketing information.

26. The computer implemented system of claim 25, wherein said partner server comprises a store configuration module that generates an application interface for creating a mobile application storefront configurable on one or more of a plurality of device platforms and hosted on said marketing server, wherein said application interface enables said user to one of purchase said one or more mobile applications and obtain information on said one or more mobile applications.

27. The computer implemented system of claim 21, further comprising a mining server in communication with said distribution server via said network, wherein said mining server comprises a data mining engine that generates and updates a distribution database in said distribution server with information related to said one or more mobile applications, wherein said distribution database stores preferences associated with said one or more mobile applications received from said user for said generation of said reference pointer to each of said one or more mobile applications by said transaction module in said transaction management server.

28. The computer implemented system of claim 21, wherein said distribution server further comprises an availability determination module that determines availability of said one or more mobile applications on said distribution server based on said acquired identification information, said determined network service information, and said determined characteristic information of said mobile device, wherein said availability determination module redirects said user to one or more available mobile applications on said distribution server, on determining unavailability of said one or more mobile applications on said distribution server.

29. The computer implemented system of claim 21, wherein said delivery and messaging engine of said distribution server transmits one or more messages to said mobile device of said user via one or more messaging servers for reinitiating said delivery of said one or more mobile applications and for requesting feedback on said delivery and quality of said one or more mobile applications.

30. A computer program product comprising computer executable instructions embodied in a non-transitory computer readable storage medium. wherein said computer program product comprises:
a first computer program code for acquiring identification information of a mobile device of a user and one or more mobile applications by a distribution server, wherein said distribution server communicate with a transaction management server via a network;
a second computer program code for determining network service information and characteristic information of said mobile device based on said acquired identification information;
a third computer program code for allowing said transaction management server to initiate a mobile application delivery transaction based on said determined network service information and said determined characteristic information of said mobile device, wherein said mobile application delivery transaction generates a reference pointer for each of said one or more mobile applications; and
a fourth computer program code for delivering said reference pointer to said each of said one or more mobile applications to said mobile device of said user based on one or more of said determined network service information and said determined characteristic information of said mobile device, wherein said reference pointer enables said user to perform actions associated with said each of said one or more mobile applications.
